(19) United States
(12) Patent Application Publication
(10) Pub. No.: US 2004/0249497 A1
(43) Pub. Date: Dec. 9, 2004

(54) System, method and process for order and delivery of classified goods and services through an amalgamated drive-thru complex

(75) Inventors: Michael Saigh, La Mesa, NM (US); Steve Beardsley, La Mesa, NM (US)

Correspondence Address: Kevin Lynn Wildenstein, Southwest Intellectual Property Services, LLC, Suite 8, 6700-B Jefferson NE, Albuquerque, NM, 87109, US

(73) Assignee: AutoCart, LLC

(21) Appl. No.: 10/807,496

(22) Filed: Mar. 23, 2004

Related U.S. Application Data
(63) Continuation-in-part of application No. 09/614,821, filed on Jul. 12, 2000, now abandoned.

(51) Int. Cl. G06F 7/00; H04Q 11/00; H04L 12/50; E04H 3/04; B61B 1/00; B65G 1/00; E04H 3/00

(52) U.S. Cl. 700/216; 186/41; 186/53

(57) ABSTRACT

The present invention comprises, in one embodiment, a system, method and process for delivery of classified goods and serviced items through a vehicle drive-thru facility, the facility having a plurality of vehicle drive-thru pick-up portals for goods or services orderable via an electronic or computer medium. The present invention comprises, in another embodiment, a process for operating a multi-lane, drive-thru, consolidated retail or commercial supercenter mall featuring specialized facility designs, high-speed order processing, warehouse management, order consolidation and delivery system of amalgamated classified goods or services. The present invention is adapted to apply a blend of shared staffing and shared services provision, information technology and enterprise management tools, and integrated process designs to meet the needs of a variety of tenant businesses operating within a single unit.

### CLAIM OF PRIORITY

The present invention is a continuation-in-part and claims priority based upon U.S. patent application Ser. No. 09/614,821, filed Jul. 12, 2000 to Saigh et al. and titled “Vehicle Drive-thru Centralized Distribution Facility” which is hereby incorporated by reference.

### FIELD OF INVENTION

The present invention relates generally to the amalgamated operation, control and management of a retail facility, and more particularly, to a system, method or process for delivery of classified goods within a drive-thru complex or facility.

### BACKGROUND OF THE INVENTION

Others have attempted to speed up or make more convenient the shopping experience for consumers, whether for products or services. These efforts have had some limited success but still fall short of providing consumers optimum convenience and efficiency. Such efforts must also focus on the demand for competitive pricing, as providers of products and services are limited as to what they can provide to the consumer to save them both time and money.

The conventional method to allow a consumer to purchase multiple products and services from different vendors is to build retail hubs in the form of malls and strip centers. In these hubs, it is still impossible for a consumer to make a single purchase from a vendor that includes products or services from the variety of local retail hub stores available in the strip mall. Instead, a consumer must visit each store or vendor individually and pay or contract for products or services desired. In order to accomplish this, the consumer must leave their vehicle, walk to each vendor individually and quite possibly make one or more trips back to their vehicle to deposit the products purchased from one vendor, or, carry their purchases from vendor to vendor. The current shopping experience is most convenient when the consumer has the ideal mix for their needs at that time within one local retail hub. However they still must go to each vendor individually.

Known vehicle drive-thru and drive-up structural configurations typically accommodate one vehicle at a time and include either a single drive-thru/drive-up portal configuration, or, in some cases, a first pay window and a second pick up window. These configurations exist, for example, in many fast food restaurant locations. There are distinct disadvantages with this approach. For example, when only one vehicle can be waited on at a time, a waiting line forms, slowing down the service and causing an inconvenient wait. In addition, the order processing is typically designed mainly for walk-in customers. Moreover, the drive-thru/drive-up portals are generally designed as add on stations that have secondary importance to walk-in service and thus, the building structure is not configured for efficient vehicle drive-thru/drive-up service.

In addition, current vehicle drive-thru/drive-up structures typically provide single category goods, such as a single location for drive-thru prepared fast foods, a single location for drive-thru pharmaceuticals, photos, dry cleaning, liquor, banking, limited convenience items, and other singular product lines, all locations which are limited in product width and depth. The limited product availability and product variety is also a result of current structural configurations which typically cannot accommodate a wide variety and scope of products. Further, order processing is generally singular in nature and limited to a few items due to the time it would take to complete and process the customer order under known structural configurations.

A substantial disadvantage to expansion of product line end number or items available to current drive-thru facilities is the resulting proportionally reduced order processing speed. The limited product availability to the customer makes it necessary for the customer (if seeking the convenience of drive-thru/drive-up service) to drive to several locations that specialize in various items. The drive-thru patron orders products from several locations and pays for the products separately at each drive-thru location and facility. In addition, the drive-thru patron waits for each order to be processed and filled and manually handed to the customer. This results in lost time to the patron, as well as the added cost of traveling from location to location to obtain the desired products or services.

More recent attempts at providing consumer convenience has been made through the shop at home movement via electronic means or telephonic means. Although this method provides the consumer with some convenience, there are still many disadvantages with this form of shopping. Unless there is a catalog readily available to the consumer, or unless some type of product or service identifier exists (e.g., pictures, text description), the vendors still have to ask consumers a series of questions to arrive at the desired product or service, thereby making the order process longer. The consumer must then wait for the product to be shipped, or the service performed, which may take days if not weeks. Further, even if a consumer desires this method of order processing, there may be problems in the delivery (e.g., wrong delivery times, incorrect delivery addresses, forgotten delivery times, and unforeseen delays). Moreover, the current parcel delivery business typically retains a huge amount of parcels because no one is home to sign and accept the delivery.

The emergence of e-commerce purchases (such as, for example, through the Internet or like global computer network) offers virtually unlimited product and service variety, virtual shopping and the convenience of ordering from the home or office. There are many advantages with this type of order processing. For example, the ordering of goods or services through e-commerce eliminates fighting traffic, finding parking, walking to several retail shops, ordering and paying for desired items, and often carrying the item to vehicles. However, the cost of direct e-commerce parcel delivery or shipping to a consumer's home is expensive and is usually directly passed on to the customer through shipping and handling charges. Product returns add even more cost and time for the customer. Moreover, a majority of parcels are delivered during the weekday when the customer is not at home, and often, the parcel will not be delivered unless the customer signs for the package. In these instances, a notice is either left at the customer's door stating that the service will attempt to deliver the package the next day or, in some cases, the package must be picked up at an office or delivery hub. Another disadvantage relative to direct e-commerce delivery is that if the parcel is delivered and placed on the doorstep or other insecure location, the parcel is subject to weather and environmental conditions, or theft and vandalism.

While purchasing goods or services through the Internet offers convenience to the consumer, it can result in poor service in detail interactions between vendor and customer. Also, such purchases suffer from the same delivery obstacles as the phone/catalog sales vendors.

The prior art discloses numerous methodologies of order processing. For example, U.S. Pat. No. 4,554,873 to Rex describes a sorting and delivery system primarily used for mail or other small types of items using self powered trolleys, which run on tracks through out the facility. The limitations of the self powered trolley type of delivery system makes it completely useless for systems requiring high speed material handling technologies which have the capacity to rapidly handle and carry items of differing sizes and weights.

As another example, U.S. Pat. No. 4,735,289 to Kenyon describes a dispensing apparatus for use from an open window of a stationary vehicle. The apparatus disclosed in this patent dispenses certain limited items using a single unit. It discloses an ordering punch key device that then either dispenses the product contained within it (such as cash or mail) or then is mechanically loaded a predetermined product mix to be dispensed. However, this disclosure is limited in that it fails to disclose individual ordering and delivery stations being staged at different multiple configurable locations within and around the facility which facilitates faster movement of traffic (and hence, higher volume of purchases). This disclosure is also deficient in that it only discloses the dispensing of limited items that can be dispensed through an open vehicle window so that in most cases, it is intended for the driver to get out of the vehicle to load the order in the trunk or backseat or other storage area depending on vehicle type. As such, this disclosure fails to take into account order delivery of products having a variety of sized and/or quantities. A similar disclosure and similar shortcomings is found in U.S. Pat. No. 5,063,857 to Kissel.

U.S. Pat. No. 5,095,195 issued to Herman describes a process for remotely ordering a videocassette which will be picked up by a customer at an automated video-dispensing unit located at the front of a video store. The customer, however, still has to leave their vehicle to retrieve the video. Also, there is no way to expand the cassette product being picked up into other product types or sizes, and there is no other products available for ordering under this disclosure.

U.S. Pat. No. 5,482,139 to Rivalto describes an automated drive-up vending facility with two product selection displays and small dispensing chutes on two of the sides of a small building. This disclosure has a very limited product selection due to the small size of the facility which is similar to a small convenience or gas store. Moreover, the size of the dispensing chutes restricts the sizes of the products which may be sold by the vendor. Additionally, the disclosure only takes non-cash payments. This disclosure also fails to disclose on-line ordering over a computer network. A similar disclosure is found in U.S. Pat. No. 5,586,686 to Bustos. The Bustos disclosure describes a system for the vending of food products (such as individually packaged beverages) from a temperature maintained storage unit to a remote location such as a service counter or the service island of a gasoline service facility. This disclosure discusses the remote delivery of one item at a time and only items that fit within the narrow size constraints of the pneumatic tube system employed for the delivery. The restricted number of items to be sold are not only limited primarily to food but to food items that can fit within the pneumatic system on its own or in containers that would fit within the pneumatic system, and which are intended for immediate consumption by a consumer.

U.S. Pat. No. 5,595,263 to Pignataro describes a merchandising apparatus and method wherein there is provided an upstanding hollow structure which is multi-sided and has grid walls defining a series of compartments. The structure has vertical columns surrounding it and guiding robot carriages carrying robots, which can reach into the compartments, withdraw articles and place them onto a conveyor. This disclosure is deficient because there is a limitation on the number of vehicles that can be serviced from a single configuration. The order stations are situated in a way that allows only one car to order from each side from particular merchandising column divisions. After the order, the consumer must drive their vehicle alongside a display case of impulse or “after-thought” items. As the vehicle passes by, a manual or electronic release can be activated that puts the after-thought item on a transfer conveyor to be added to the original order. This order is then processed and the goods are loaded directly in to cars by an attendant. To obtain refrigerated products, the customer must repeat the purchasing process for those items. This disclosure is deficient because it requires multiple stops for a consumer, which is not convenient.

U.S. Pat. No. 5,890,136 to Kipp describes an automated store that uses remote ordering of products to an offsite location which then communicates with a single store vendor where the order is held unpicked until the customer comes to the automated store and enters an ID card or code. Upon entry of this code, the store will dispense the item(s) into a retrieval basket which is then sent to an article pickup area where the customer can retrieve their order. This patent fails to disclose a process that allows a consumer to purchase multiple items or services (e.g., banking, movie rental, liquor, pharmacy, grocery) from multiple retail vendors in a single location. Moreover, this disclosure is limited to two random pickup areas, which, during high traffic times, will result in delay and consumer frustration. Additionally, this disclosure fails to appreciate the need for automated pickup stations which are operated by software systems designed to optimize traffic flow based on the items ordered. Moreover, this disclosure is deficient because it relies on an offsite remote location to receive specific commands through a touch-tone keypad, which removes the customer from communicating with a live attendant who can provide great interaction to the consumer with exceptional service. This disclosure also fails to appreciate the ability to offer additional items to a consumer which are not stored at the facility.

U.S. Pat. No. 6,032,126 to Kaehler describes an apparatus for installation in a retail setting for selling fuel and other non-fuel products. This disclosure is directed towards a gas station or convenience store setting. Because of this setting, this disclosure will fail to accommodate consumer orders which require a large product selection or bulk ordering capability. Moreover, this disclosure requires that for any items ordered, the consumer must first obtain a document evidencing the order, must leave their vehicle and obtain the items ordered from a station attendant upon presentation of the document. Further, this disclosure is deficient because it relies on oral voice communication to place the order. In many instances, a consumer may want to visually view the items being ordered rather than rely on voice communicated orders. Additionally, this disclosure's system of selling fuel and non-fuel items is in a retail setting is not suited to receive courier parcels on behalf of the customer, nor does this system offer mailing or shipping as a service. The primary design of buying fuel products first, and other non-fuel products second, does not inherently or expressly suggest that the gas station facility is being used as a repository for picking up Internet orders delivered to the fuel station. And, this disclosure fails to recognize that consumers would embrace purchasing items from a plurality of various pre-selected vendors, all offering their products in one drive-thru facility that allows the customer to order and receive the products right at their vehicle.

What is required is a system, process or method for delivery of classified goods and services through a multi-lane drive-thru complex which will change in the way retailing is provided to consumers today. In particular, what is needed is a novel and unique blend of convenience (a singular provider of multiple classified goods and services, such as those found in the United States U.S. Standard Industrial Classification, the North American Industry Classification System) and like classification methods in foreign countries, and efficiency (multiple order processing and/or delivery station) for consumers to pickup their orders directly at their vehicle through a consolidated fulfillment and execution system that is optimized to house several types of retail or commercial tenants within the same structure. Such a system would require a combination of technologies, distribution systems and software computing systems and tenants which are integrated to benefit both consumers and vendors at a single geographic location. The present invention satisfies this need.

### SUMMARY OF THE INVENTION

The following summary of the invention is provided to facilitate an understanding of some of the innovative features unique to the present invention, and is not intended to be a full description of variations that may be apparent to those of skill in the art. A full appreciation of the various aspects of the invention can be gained from the entire specification, claims, drawings, and abstract taken as a whole.

In an exemplary embodiment of the invention, the present invention is a process for controlling, operating and directing a vehicle drive-thru or drive-up facility complex which inventories a wide variety of convenience non-durable goods as well as durable goods that lend themselves in size and sales volume to the structural facility and surrounding demographics. The complex may provide thousands of convenience items such as a grocery store, drug store, and items found in major discount retailers, factories, and general merchandise stores, all from pre-selected tenants. In addition, the structure is linked to e-commerce products ordered via the Internet.

In another embodiment, a number of e-commerce tenants unrelated to the prime tenant or facility manager are connected to the facility web site and have postings thereon. Customers are allowed to order inventoried items, or web products offered by those vendors on the facility web site. Web vendors that do not post their products directly on the facility web site are able to earmark distribution of their products to the facility complex through various parcel delivery services or shipping companies. In this manner, the facility is linked to thousands of e-commerce sites enabling consumers to order e-commerce products directly through the prime vendor's facility web site.

The vehicle drive-thru/drive-up facility complex centralizes the delivery of e-commerce goods and provides a convenient vehicle drive-up facility for customer service and product returns. Each complex hosts a web site including products offered by the facility and links to other web sites allowing for a full range of product and service offerings.

The novel features of the present invention will become apparent to those of skill in the art upon examination of the following detailed description of the preferred embodiment or can be learned by practice of the present invention. It should be understood, however, that the detailed description of the preferred embodiment and the specific examples presented, while indicating certain embodiments of the present invention, are provided for illustration purposes only because various changes and modifications within the spirit and scope of the invention will become apparent to those of skill in the art from the detailed description, drawings and claims that follow.

### BRIEF DESCRIPTION OF THE DRAWINGS

The present invention may be described herein in terms of functional block components and various processing steps. It should be appreciated that such functional blocks may optionally be realized by any number of hardware, firmware, and/or software components configured to perform any of the specified functions or steps. For example, the present invention's computer systems may employ various computing systems, including memory elements, digital signal processing elements, look-up tables, databases, and the like, which may carry out a variety of functions under the control of one or more microprocessors or other control devices. Further, any software or hardware optionally employed may communicate through any known network such as the Internet. Such general techniques and components that are known to those skilled in the art are not described in detail herein. It should further be understood that the exemplary process or processes illustrated may include more or less steps or may be performed in the context of a larger processing scheme. Furthermore, the various flowcharts presented in the drawing figures are not to be construed as limiting the order in which the individual process steps may be performed.

The accompanying figures further illustrate the present invention and, together with the detailed description of the preferred embodiment, assists to explain the general principles according to the present invention.

FIG. 1 is a side schematic view of an exemplary vehicle drive-thru/drive-up facility complex in accordance with one embodiment of the invention;

FIG. 2 is a top schematic view of a first floor of the embodiment shown in FIG. 1;

FIG. 3 is a top schematic view of a second floor of the embodiment shown in FIG. 1;

FIG. 4 is a schematic view of a plurality of tiered pick-up portals for the embodiment shown in FIG. 1;

FIG. 5 is an illustrative diagram depicting exemplary drive-thru and order staging lanes according to one aspect of the present invention;

FIG. 6 is an illustrative diagram depicting exemplary order placement and order delivery stations according to one aspect of the present invention;

FIG. 7 is an illustrative diagram depicting exemplary traffic routing for order delivery or alternate handicap and special assistance delivery stations according to one aspect of the present invention;

FIG. 8 is an illustrative diagram depicting an exemplary order input means from a customer's vehicle via a wireless touch screen device according to one aspect of the present invention, the left illustration depicting the device attached to a kiosk, the right illustration depicting the device attached to a docking station;

FIG. 9 is an illustrative diagram depicting an exemplary customer order input means from a customer's vehicle via a wirelan touch screen according to one aspect of the present invention, the left illustration depicting the device attached to a kiosk, the right illustration depicting the device attached to a docking station;

FIG. 10a is an illustrative diagram depicting another aspect of the exemplary customer ordering drop screen according to the present invention, the diagram illustrating a plurality of orientations and angles for placement of the ordering drop screen, the present invention not being limited to the illustrated orientations and angles, the left illustration depicting a representative front or rear side view, the right illustration depicting a representative left side view;

FIG. 10b is an illustrative diagram depicting another aspect of the exemplary customer ordering drop screen of FIG. 10a with the screen 11 being attached to poles, the left illustration depicting a representative front or rear side view, the right illustration depicting a representative left side view;

FIGS. 11a and 11b are illustrative diagrams depicting exemplary customer ordering drop screen with alternate pole attachment, the present invention not being limited to the illustrated orientations and angles;

FIGS. 12a and 12b are illustrative diagrams depicting exemplary traffic control multiple light placement;

FIG. 13 is an illustrative diagram depicting an exemplary interior walk-in portion of the present facility;

FIG. 14 is an illustrative diagram depicting exemplary tenant areas within a portion of the present facility;

FIG. 15 is an illustrative diagram depicting an exemplary order flow process according to one aspect of the present invention;

FIG. 16 is an illustrative diagram depicting an exemplary on site customer order entry process according to one aspect of the present invention;

FIG. 17 is an illustrative communications diagram of the present invention's CORE process or facility process control;

FIG. 18 is an illustrative diagram depicting an exemplary on-site order process according to one aspect of the present invention;

FIG. 19 is an illustrative diagram depicting an exemplary order fulfillment process according to one aspect of the present invention;

FIG. 20 is an illustrative diagram depicting another exemplary order fulfillment process according to one aspect of the present invention;

FIG. 21 is an illustrative diagram depicting an exemplary order response process according to one aspect of the present invention;

FIG. 22 is an illustrative diagram depicting an exemplary communication network alternatives including real time two-way video linking;

FIG. 23 is an illustrative diagram depicting an exemplary drive-thru annex adaptation of the present invention to an existing box store or stand alone store;

FIG. 24 is an illustrative diagram depicting an exemplary drive-thru annex adaptation of the present invention to an existing strip center type mall; and

FIG. 25 is an illustrative diagram depicting an exemplary drive-thru annex adaptation of the present invention to an existing indoor or traditional mall.

Additional aspects of the present invention will become evident upon reviewing the non-limiting embodiments described in the specification and the claims taken in conjunction with the accompanying figures, wherein like reference numerals denote like elements.

### DETAILED DESCRIPTION OF THE PREFERRED EMBODIMENT

The present invention is directed towards, in one embodiment, a system, process or method for controlling, operating or otherwise directing the delivery of classified goods and services through a multi-lane drive-thru facility or complex wherein the multiple classified goods and services are based on the United States U.S. Standard Industrial Classification (SIC) or the North American Industry Classification System (NAICS) as identified, for example, in the Table 1 submitted with this disclosure. The present invention allows for consumers to pickup their orders directly at their vehicle through a consolidated order fulfillment system which is optimized to house several types of retail or commercial tenant(s) within the same structure at a single geographic location. As used herein, the term “tenant” or “tenants” may refer to a single or multiple tenant, vendor or vendors, manufacturer or manufacturers, owner or owners, or may refer to a single or multiple direct supplier.

The present invention allows the various tenants residing within the facility to communicate amongst themselves or with customers (locally or remotely) through a centralized communication linking audio system and/or an audio video network which may be connected to a global computer network such as the Internet. As used herein, the term “network” refers to any electronic interconnection between two or more electronic devices over which data is transferred, including, but not limited to, the Internet, an intranet, a land line or traditional telephone network, a cellular or wireless mobile network, a wireless microwave network, television or radio wave transmissions, a cable network, a wireless connection (for example, infrared or microwave connections), satellite, a localized land network system, induction connection using electric lines, a wireless network using lasers as the transmitting medium, any combination of any of the preceding or any other system for the transmission of data between two or more units. A “secure network” is a network employing security measures against unauthorized access to data being transmitted via the network or data stored within a memory storage area of a device connected to the secure network. And, the term “facility” may refer to a multi-story building; a single level building and a site built custom designed building that is location specific as to marketing needs and site ramifications.

The present invention may be embodied as a system, process or method. Other variations and modifications of the present invention will be apparent to those of ordinary skill in the art, and is not limited except by the appended claims. The particular designs and configurations discussed herein can be varied, and are cited to illustrate particular embodiments of the present invention. It is contemplated that the use of the present invention can involve components having different characteristics as long as the principles disclosed herein are followed.

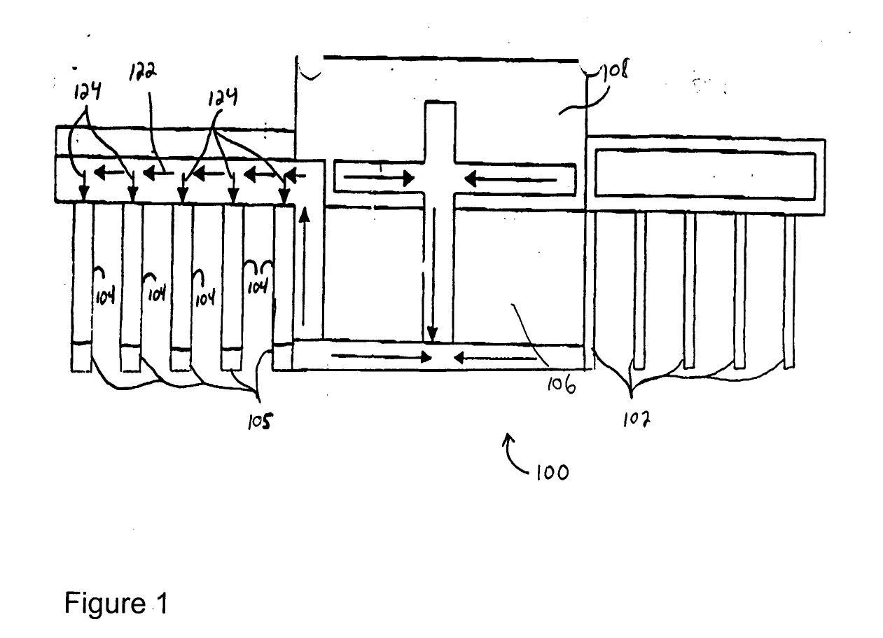

FIG. 1 illustrates a graphical view of one exemplary embodiment of a vehicle drive-thru/drive-up facility complex 100 which provides multiple classified goods and services that includes a plurality of order placement stations 102 and a plurality of drive-thru and/or pick-up portal areas 104 (hereafter collectively referred to as “drive-thru area”). Drive-thru area 104 each includes a pick-up portal 105. In one embodiment, complex 100 includes at least three order placement stations and at least three drive-thru areas. In alternative embodiments, complex 100 includes one order placement station and one drive-thru/pick-up portal area or five order placement stations and five drive-thru area. In a further alternative embodiment, complex 100 includes a predetermined number of order placement stations 102 and drive-thru/pick-up portals 104 corresponding to the particular configuration of the facility.

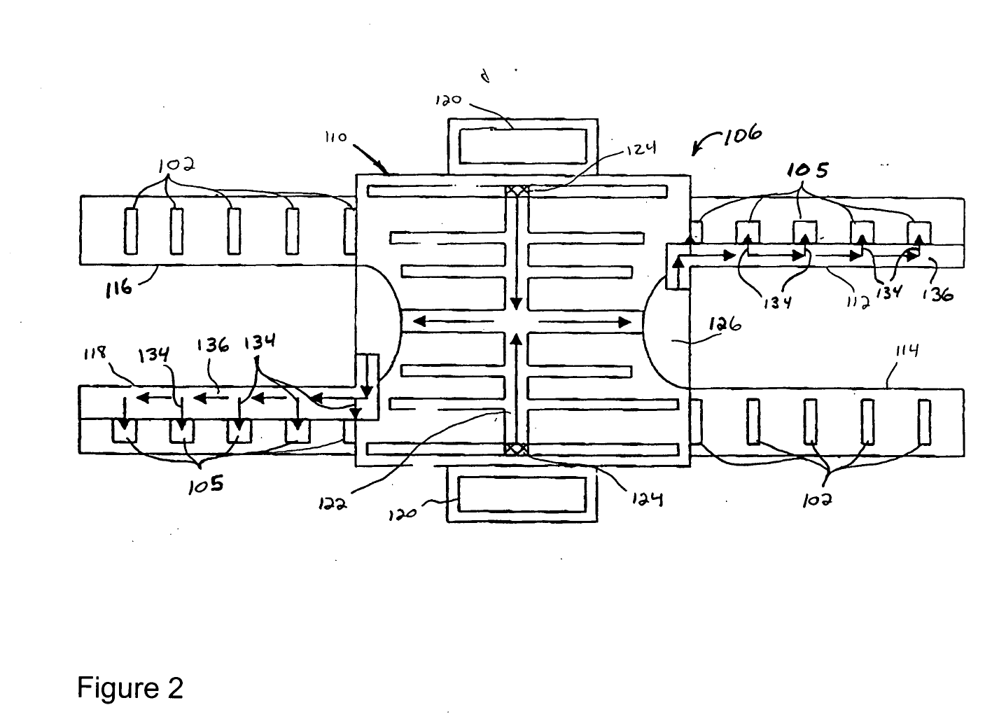

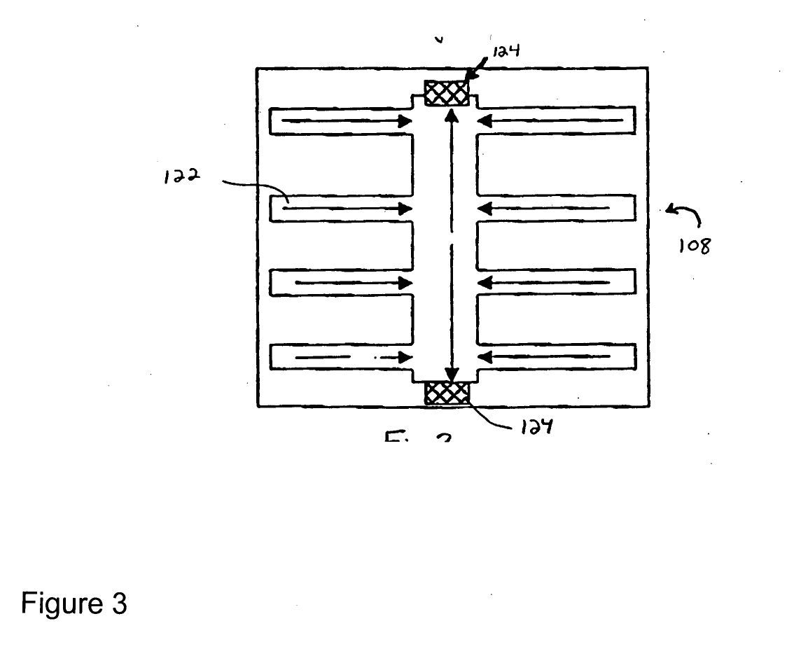

As seen in FIGS. 2 and 3, complex 100 may, in an exemplary embodiment, include at least a first floor level 106 and a second floor level 108 for providing multiple classified goods and services as will be described in detail below. Other embodiments of complex 100 can have any configuration, including multi-level or one-story, which is adapted for the particular area in which complex 100 is located. The configuration is determined by considering factors including, but not limited to, the demographics, the land lot size, the desire for pick-up portals 105, the traffic, the population, and the zoning laws of the particular area. In one embodiment, each order stations will have a corresponding pick-up portal.

Exemplary facilities which provide multiple classified goods and services may require an elongated structure with numerous order placement stations and pick-up portals along one side or both sides of the facility. Other exemplary facilities may require wide structures with order placement stations and pick-up portals along one or both sides. Still other exemplary facilities may require long and wide structures with numerous order placement stations and pick-up portals arranged throughout the facility, or circular facilities with order placement stations and pick-up portals strategically placed throughout the facility. In addition, a parking lot (not shown) may be located on the premises to accommodate walk-in customers and parking for personnel.

FIGS. 2 and 3 illustrate exemplary top graphical views of a multi-floor facility having at least a first floor 106 and a second floor 108 of a vehicle drive-thru/drive-up facility complex 100. First floor 106 may include a centralized portion 1 10 and a plurality of extension portions 112, 114, 116, and 118 that extend from centralized portion 110.

Centralized portion 110 may include at least a pair of customer service windows 120 accessible from outside complex 100. Customer service windows 120 may be utilized to process walk up orders as well as to process returns and respond to customer inquiries and concerns. In addition, customer service windows. 120 may be utilized to distribute special orders and large volume orders. Alternatively, separate windows, or portals, can be utilized, e.g., a customer service window, a return window, a special order window, and a large volume order window. In one embodiment, customer service windows 120 may be placed along one or both sides of complex 100. Alternatively, customer service windows 120 may be located on one or both ends of complex 100, or on the interior of first floor 106 of complex 100 for customer convenience. The term “customer” includes any person, retail store,.wholesaler, home, organization or governmental department or affiliation. In other words, a “customer” is defined as any person or entity that shops for any type of good or service.

As seen in FIG. 2, first floor 106 may also include a horizontal inventory access system 122 adapted to transport classified goods or serviced items from a plurality of vertical inventory access systems 124 to a final order assembly and consolidation area 126. Horizontal inventory access system 122 may be any type of automated or mechanical system for the movement of goods in a horizontal plane. Exemplary horizontal inventory access systems include, but are not limited to, conveyor belt systems, automated carts, remote control delivery systems, robotic delivery systems, computerized movement systems, combinations thereof, and other similar types of automated or mechanical delivery systems. Automated carts or totes include any system for the movement of goods or serviced items using an automated vehicle, cart or tote for the delivery of goods from one point to another specific point. The term includes radio-controlled vehicles, driverless mobile carts utilizing radio or infrared or magnetic connections or wirelan electronic carts, robotic vehicles and other similar types of devices. Vertical inventory access system 124 may be any type of automated or mechanical system for the movement of goods or serviced items in a vertical plane. Exemplary vertical inventory access systems include, but are not limited to, elevators, dumbwaiters, hod conveyor systems, bucket and chain systems, robotic systems, combinations thereof, and other similar types of automated or mechanical delivery systems. The combined utilization of both a horizontal inventory access system 122 and a vertical inventory access system 124 allows the facility 100 to move goods and/or serviced items in any angular direction, whether the facility 100 is a single story structure or a multi-story structure. Additionally, those of skill in the art will realize that the combined utilization of both a horizontal inventory access system 122 and a vertical inventory access system 124 may be accomplished by a single inventory access system.

All classified goods or services are preferably housed within complex 100. In addition, complex 100 may include at least two final order assembly and consolidation area 126 as seen in FIG. 2. Final order assembly and consolidation area 126, in one embodiment, may have a semi-circular shape. In alternative embodiments, final order assembly and consolidation area 126 may be circular shaped or have any other shape that supplies adequate support for the delivery of classified goods or services through complex 100 to a customer.

In this embodiment's operation, the facility is adapted to receive a customer order at order placement station 102 via electronic ordering means (not shown). The electronic ordering means may be an electronic device adapted to receive voice commands. The electronic order means may also include a LCD screen, LED screen, a projection system, a plasma screen, a touch screen or other order input means which visually communicates with the customer, whether being tethered or not, or whether physically present within the vehicle or not. Optimally, the electronic ordering means is placed in a location which facilities a customer's of the ordering screen from the vehicle. When an order is received by the facility through the order input means, the facility's electronic processing means (not shown) processes the order to electronically dissect and disseminate the order to the appropriate area of the facility complex 100 for further processing by the facility tenant or tenants (if the order involves goods or services from different tenants). The goods or service items that have been ordered are transported to final order assembly and consolidation area 126 via either or both of horizontal delivery system 122 and vertical delivery system 124. The ordered goods are then combined into one or more containers or totes for delivery to an appropriate pick-up portal 105 for delivery to the customer. Goods to be picked up are moved from final order assembly and consolidation areas 126 to pick-up portals 105 through a delivery system, such as for example a combination of a vertical delivery system 134 and a horizontal delivery system 136 as seen in FIG. 2. In alternative embodiments, pick-up portals 105 may include ramps, hook and bar mechanisms, vacuum-type tubes, or any mechanical mechanisms to deliver the ordered goods and services to the customer in a safe and secure fashion. Pick-up portals 105 may also be arranged in a linear configuration. In a representative linear configuration, portals 105 are lined up along a straight line with a single horizontal delivery system 136 connecting a separate vertical delivery system 134 for each separate portal 105.

The customer, in most cases, remains in his/her vehicle during the transport of the goods and services to the automobile. However, if a parcel is too heavy or too large to be delivered through a window of the vehicle, facility complex 100 includes ample room for the customer to exit the vehicle, pick up the item, and place the item in the vehicle. In alternate embodiments, pick-up portals 105 also include a pressure-controlled drawer (not shown) for the delivery of small items and food and beverages. The pressure-controlled drawer is preferably adapted for sensitivity to prevent items from spilling or leaking.

In addition, complex 100 is configured to accept returned goods or service items (such as, for example, clothes in need of dry cleaning or a video in need of return to the video rental tenant). If a customer desires to return an item, several options are available. If the item is sized appropriately, the customer may place the item on vertical delivery system 134 at pick-up portal 105. Alternatively, if the item is too large to be placed on vertical delivery system 134, the item can be dropped off, either mechanically or by other means, at customer service window 120.

Facility complex 100 processes orders received from order placement stations 102 when customers order in person through a facility processing means (not shown, but hereafter referred to as the Comprehensive Order Response Enterprise system, or CORE) which may be electronic, computer, software or hardware based, or any combination thereof. In addition, goods and services can be ordered in advance and received by facility complex 100 via telephone, a computer network such as the Internet, cellular phone, microwave communications, radio frequency, satellite communications, wireless personal digital assistants (PDAs), facsimile transmission or other order communication means. In addition, the customer may place cellular orders using radio “bluetooth”, infrared, microwave, RF, satellite or other mobile wireless systems. When classified goods or serviced items are ordered in advance, the facility is adapted to receive the order, assemble the order and place the ordered goods or serviced item in a staging area to await customer arrival and pick-up. The order processing means will hold any time sensitive or perishable items separately, but later, will place these items with the other ordered items when the customer arrives to assure freshness and safety of the ordered goods. Large items that exceed the size allowed by pick-up portals 105 are taken to customer service window 120 where the facility provides manual assistance if desired by the customer. Those of skill in the art will now realize that any number of communication protocols may be employed to realize the present invention, including voice transmission, by voice synthesizer transmission, by audio transmission, by audio-visual transmission, by radio frequency transmission, by electronic signal transmission, by a touch screen; including by any type of wireless protocol comprising cellular, microwave, IEEE 802.11x, Bluetooth, satellite; and including by wirelan protocol comprising a telephone, a handheld devices, an onsite or offsite communication device, a point device, a touch device, a personal computer or any combination thereof.

The CORE system 27 may be connected to other computer systems locally or remotely over a network. The network may be a public network and assumed to be insecure and open to eavesdroppers. In the illustrated implementation, the network may be embodied as the internet. In this context, the computers may or may not be connected to the Internet at all times. Specific information related to the protocols, standards, and application software utilized in connection with the Internet may not be discussed herein.

In another embodiment of the present invention, the CORE computer system is adapted to monitor or otherwise sense vehicle emissions and/or pollutants. When a pre-defined level of emissions is sensed by the CORE computer system, the CORE computer system may then control one or more exhaust control systems in the facility to vent away, or otherwise remove the emissions to a level acceptable to the CORE computer system.

Those of skill in the art will realize that the CORE system of the present invention (and any element which communicates with such system) may be described herein in terms of functional block components, and various processing steps. It should be appreciated that such functional blocks may also be realized by any number of hardware and/or software components configured to perform the specified functions or steps. For example, the present invention may employ various computing systems, including memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, XML, COBOL, assembler, PERL, or the like, with the various algorithms being implemented with any combination of data structures, objects, processes, routines or other programming elements. Further, it should be noted that the present invention may employ any number of conventional techniques for data transmission, signaling, data processing, network control, and the like.

In an exemplary embodiment, the processing of the ordered goods and services and a running inventory of complex 100 is controlled via the use of labels (not shown) including, but not limited to, UPC codes, radio frequency identification (RFID) on individual goods as well as case containers and bulk packaging, bar codes, SKU codes, biometric identification, customers name or order number. The labels reduce the possibility of processing mistakes by reducing the opportunity for human error. Almost every commercial retail good contains a UPC code. The CORE system 27 may use the UPC code as a common link of identification and control, which can then be transmitted to a variety of end users, such as tenants and wholesalers. Also, the UPC codes may include an expiration date in order to automatically alert the customer and/or reorder the corresponding product upon product expiration. In addition, the labels reduce costs associated with processing orders.

According to one aspect of the present invention, customers may pay for the ordered classified goods or services via one or more of cash, check, credit card, or speed pass or other payment processing means. Facility complex 100 may utilize the direct identification of credit/debit cards and accounts in order to automatically bill the customer. Cash and checks may be sent through a vacuum-type tube at order placement stations 102. In an alternative embodiment, a customer may prepay for the order on the facility complex Internet web site or by whatever means the order was placed (such as an order communication means). The customer may then be assigned a personal identifying number (i.e., pin number) by the web site or other order communication means. Once the customer arrives at complex 100, the customer enters their assigned pin number at pick-up portal 105 to verify they have prepaid for their order. Alternatively, facility complex 100 may be adapted to utilize voice recognition in order to verify the identity of a customer. The order is then delivered to pick-up portal 105.

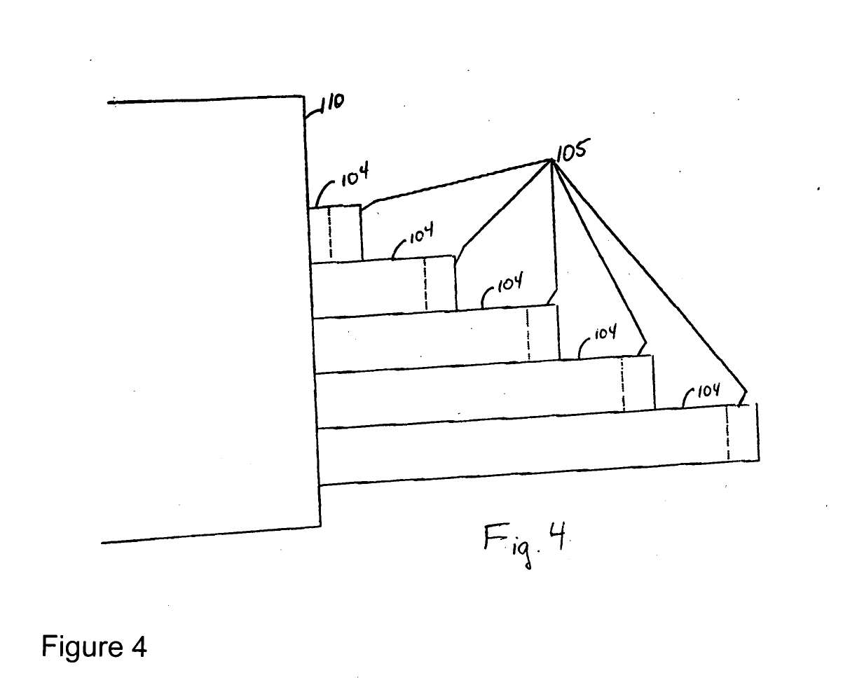

FIG. 4 illustrates a representative graphic depicting a plurality of drive-thru pick-up areas (DTPUP) 104 arranged in this embodiment in a tiered configuration, attached to centralized processing portion 110, for vehicle drive-thru/drive-up facility complex 100. Each DTPUP area 104 may include a pick-up portal 105.

Each DTPUP area 104 is configured similarly to commercially available drive-thru areas for facilities such as banking establishments with multiple portal areas but having unique characteristics according to the present invention. For example, DTPUP area 104 has a configuration that allows for easy movement of a vehicle through it, allows for a driver to exit and enter the vehicle and access the trunk, and for installation of pick-up portal 105 on a driver*s side of the structure. Conventional drive-thru banks do not offer the additional space as it is not necessary for such space. As such, in one embodiment, DTPUP area 104 is open on two sides and closed on one side. In an alternative embodiment, DTPUP 104 is also closed on the fourth side. A ceiling of DTPUP area 104 is sufficiently high to allow most standard vehicles to enter DTPUP area 104. In addition, DTPUP area 104 is sized to allow for installation of an appropriate horizontal delivery system (not shown in FIG. 4) for each pick-up portal 105.

An delivery processing means (not shown) operates horizontal delivery system 136 (shown in FIG. 2) and may be programmed to deliver a specific package of goods to a pick-up portal 105 for the specific portal vertical delivery system 134 (shown in FIG. 2). Upon arrival at the specified opening, the package of goods is automatically transferred from horizontal delivery system 136 to the appropriate vertical delivery system 134 for the specified portal. For multiple story facility complexes, in addition to the automated linear configuration and the tiered configuration, there may be a semi-automated system for both the linear and tiered configurations. The semi-automated configuration may utilize a human to move the package of goods from horizontal delivery system 136 to vertical delivery system 134.

In an alternative embodiment, complex 100 employs combinations of one and two tiered order placement stations 102 and one and two tiered pick-up portal and linear pick-up portal area 104 configurations. These combinations allow for multiple designs and any number of portals at any location or level in or around the facility. In addition, complex 100 may includes traffic control lights in the pick-up area 104, 105 to aid in directing the flow of vehicle traffic. The CORE system 27 is adapted to control traffic flow in one embodiment by controlling the number of ODS or OPDS stations available so that during off peak times fewer locations will be employed and they will spread out to further eliminate opportunities for accidents. Also if the consumer needs to go to the customer service drive-thru area for a return or replacement or go to the dry cleaning area for a pick up then the CORE system will direct them to the appropriate place and time for those additional functions to take place in a way that optimizes time and safety.

In one embodiment, complex 100 is a single level complex configured to accommodate the available real estate, demographic needs, tenant storage needs and zoning laws of a specific geographical location. In an alternative embodiment, complex 100 is a multi-level complex configured to accommodate the available real estate, demographic needs, tenant storage needs and zoning laws of a specific geographical location. Complex 100 may also be configured to accommodate parcels delivered by standard delivery companies or couriers, such as United Parcel Service, the United States Post Office, and Federal Express. In addition, complex 100 is configured to warehouse or store larger items than described above.

In one embodiment, order placement stations 102 may include video display menus listing for example, the goods and services available to the customer. In addition, order placement stations 102 may include touch screen ordering capabilities utilizing touch screen sensitivity for the ordering of various goods and services. For example, in one operational mode of the present invention, once the facility has accepted an order from a customer, an itemized list of those items appears on the video display menu, including a subtotal, tax and total. An order confirmation means, such as for example a computer with printing capabilities, will confirm the order and invoice as a customer receipt.

In another embodiment, the facility or a tenant within the facility may provide a clerk to communicate with customers for assistance with ordering, either live or through electronic means. For example, such communication may be accomplished via a video camera and audio link at each order placement station 102 and pick up portal 105, which provides visual and audio contact between the customer and the tenant's employee. Audio-visual contact may be useful for purposes of identification when ordering items, such as liquor or cigarettes, requiring an ID (driver's licenses, etc.) in accordance with local laws, as well as for customers who wish to pay through a negotiable instrument such as a draft check.

Additionally, there may be circumstances which require the special processing or delivery of the goods and services due to legal restrictions or other similar restrictions. Representative goods, services or substances may include, for example, cigarettes, alcohol, spray paint, glue, prescription drugs, banking and parcels. The CORE system 27 is thus adapted to process or otherwise authenticate identification of the customer who is purchasing the ordered good or service, verify the customer's ability to purchase the ordered good or service, and if authentication and identification is confirmed, deliver the ordered good or service to the customer. If this verification process is unsuccessful, the order will not be processed and the special handle goods or services will not be delivered to the customer. One representative verification system may include a biometric verification system whether at the facility or remotely located. By using a biometric identification system, for example, the unique of properties of each customer can be initially stored be retained on file for subsequent confirmation to whom is picking up the prescription. Such biometric verification methodologies include, but are not limited to, fingerprints, eye patterns, visual (face) identification, license scanning, voice, vehicle identification, non-invasive cell scans and others. Of course, such verifications should fully comply with applicable local, state and federal regulations. Those of skill in the art will recognize that a representative verification system can communicate with the CORE system 27 through wirelan or wireless communication means.

Video cameras allowing clerks to view lanes of traffic to pick-up portals 105 may be optionally provided to help the complex personnel assist in directing the customer where to pick-up or return goods and manage or optimize traffic flow for speedier services.

A computer system (not shown in FIGS. 1-4) may be employed within the facility 100 to monitor or otherwise process facility operations, ordering, packaging, shipping, or traffic, thereby facilitating convenience and speed while allowing retailers or tenants within the facility to expand their product lines and perform various services for consumers. The computer system will also allow communication amongst the tenants within the facility, or amongst tenants and customers. An exemplary computer system may comprise at least one server communicating with at least one computer to thereby define an electronic network using any of the commercially available network systems (e.g., land based wirelan network, cable system, wireless networking, Internet, cellular phone, dial-up telephone system, satellite networking, or other network system). A generally commercially available software package may be employed to operate the computer system. The computer system is configured to be communicatively compatible with most of the current retail and wholesale operating programs and computer operating systems in commercial use while providing a high degree of security from unauthorized access outside of the facility or outside of authorized users of the system, and which allows for layers of security to be applied depending upon the sensitivity of the data involved. The computer system may also be configured with a database for storage and retention of transactional data to allow maximum data storage and ease of access to stored data. A search engine may be included that allows maximum flexibility in accessing stored data.

When a customer communicates with the CORE system 27 from an offsite location (such as through the Internet), the ordering process will be similar to the onsite experience. This ordering method may give good consistency in the ordering process, making both online and on-site ordering easier and more comfortable for the consumer. However, when ordering on line, a customer may have access to a wider variety of classified goods or services. An exemplary e-commerce platform may allow each tenant to place links to their web sites allowing the consumer to order items that are not stocked at the facility 100. There may also be a link to the World Wide Web for unlimited shopping. Either type of ordering will allow the consumer to have their order delivered to a selected facility 100 site for pick up at their convenience.

As to process operation of facility complex 100, computer system is also configured for segmented or modular operation allowing for drive-thru line openings and closures, expanding and contracting certain processes to reflect the operational needs based on customer flow for fast and slow times or hardware reconfiguration in the event of hardware failure. The computer system may also be configured to display a presentation at the order placement screens 102 which closely matches standard available data entry formats to promote ease of entry with minimal errors.

Data error verification concurrent with the entry of customer orders are implemented to provide greater assurance of order accuracy while differentiating the various unique tenant functions into operational formats and allows an overall integration to provide total business review and management capabilities.

The disclosed computer system, in still another embodiment, may be configured to manage such clerical operations as order confirmation, printing of receipts, order pick lists, lane control, “day” reports, inventory reports, and tenant reports. Further business and office management tasks such as new customer rate, current customer flow, activity rate, data entry rate, cash flow, goal tracking, service error rate, productivity levels, staffing levels, inventory control, service selection, customer awareness, customer trends, tenant changes, tenant value(s), product value(s), legal issues, and external links may be managed or otherwise controlled by the computer system.

The facility complex is intended to provide convenient access to a large selection of classified goods and services, such as those goods and/or services classified under the SIC or NAICS classifications. The facility consolidates and provides shippable consumer goods and services offered by vendors or tenants all within a single location. Thus, for example, the present invention may provide groceries, pharmaceuticals, liquor, key duplication, video sales and rentals, clothing, photography development, dry cleaning, laundry, popular local take-out restaurants, home furnishings and cleaning supplies, office supplies, office equipment (fax and copy machines, telephones, answering machines, etc.), computers and computer supplies and computer related electronic equipment, banking/ATM and all other daily use items for the home and office, all within a single physical structure.

In other embodiments, facility complex 100 is configurable to house or otherwise receive and store special auxiliary services which best fit the demographics and zoning laws of the specific geographic area in which the complex is located. Exemplary special auxiliary services include, but are not limited to, car wash, atrium restaurant, gas station, service station, full service bank, and cleaners. The structure can be configured to accommodate small land parcels or larger land parcels, depending on the zoning laws. In addition, the structure can provide a drive-thru/drive-up warehouse and inventory facility for mall shopping retail centers, parcel and mail shipping and delivery, and general merchandise delivery.

Facility complex 100 may further include the capability of additional automated/electronic tasks. Specifically, facility complex 100 may include an automatic update system that electronically or physically communicates alerts to the customer by an alert system. Such alerts may be due to a number of circumstances, such as, for example, an alert regarding the delivery or use of a package or order, or, a special facility complex promotion including time-sensitive coupon specials, or, the completion of an order/request. In addition, facility complex 100 may employ the use of a global positioning system (GPS) in order to trace and detect the location of a customer so as to accordingly prepare an order for pickup by the customer in a timely manner. Facility complex 100 may also include an automated recipe generation system which communicates with all electronic means in the facility, and is specifically adapted to store pre-selected recipes, receive orders for the pre-selected recipe and process the order by retrieving the ingredients from the facility for delivery to the customer.

The facility complex 100 embodies a new process for ordering and delivery of classified products and services in an efficient and cost effective manner through a multi-tenant occupied structure having a multi-lane order entry and retrieval processing system. The present invention offers a high degree of flexibility in the actual flow of customer traffic and subsequent product and service delivery layouts. The present invention also offers a high degree of adaptability in the nature of the business interfaces offered to the participating tenants. Unlike a regular retail store environment with a static content/flow/owner structure, the facility complex 100 represents a dynamic environment that also reduces the cost of doing business for participating tenants by preventing certain problems and disadvantages that walk-in retailers face, such as shoplifting.

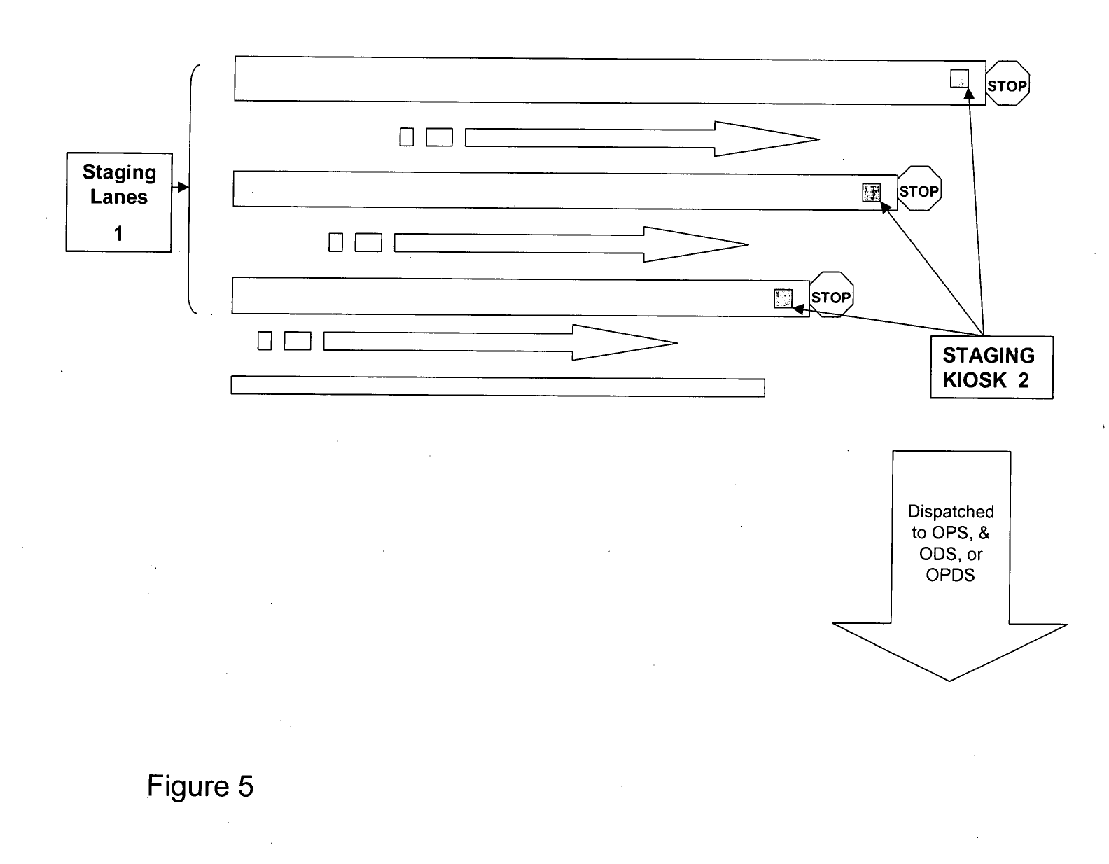

Those of skill in the art will now realize that several various alternative embodiments of the present invention may exist, which are still within the spirit and scope of the present invention. Exemplary embodiments are illustrated in FIGS. 5-25. For example, as seen in FIG. 5, the facility may be arranged to include at least one staging lane 1. The staging lane 1 may be a single staging lane or a plurality of staging lanes that perform various pre-sale or pre-order tasks when a customer arrives at the facility. Each staging lane is adapted to receive communication from a customer. For example, a customer may identify themselves to the facility as wanting to order a product or service available at the facility, or, may announce that they have already pre-ordered a good or service from a remote location over an electronic means (not shown) and desire to retrieve the order. Staging area 1 may also be adapted to provide product information to a customer such as, for example, product specials, close-outs or other pre-sales related information.

As seen in FIG. 5, staging lane 1 may include a pre-ordering communication means (not shown) which allows the consumer to communicate with the facility computers or tenants electronically, through voice transmission, audio transmission or any combination thereof. For example, the pre-ordering communication means may comprise an audio and video device adapted to communicate with the customer via pre-selected short-distance radio frequencies so that a customer may be directed to tune their vehicle radio to a specific station to obtain the particular information desired. Moreover, the pre-ordering communication means may include an order input screen adapted to receive or give instructions, or otherwise communicate with the customer. In one embodiment, the electronic ordering means may be a touch screen. In another embodiment, the pre-ordering communication means may be a screen adapted to receive instructions from the customer via wireless communication. In still another embodiment, the electronic ordering means comprises a voice recognition and voice synthesizer system adapted to receive communication from customers and respond to such communication. Those of skill in the art will appreciate that the pre-ordering communication means as used throughout this invention is not limited solely to a device which receives orders, but can be any device, apparatus, system or method for communicating with a customer for any reason.

Optional staging lane kiosks 2 may be used as a receptacle for receiving items from the customer. For example, as seen in FIG. 5, staging lane,kiosks 2 may be used to receive clothes for dry-cleaning services or for receiving returned items (such as, for example, receiving rented DVD's, VHS tapes, CD's or any other product that can be returned by using a kiosk receptacle, such as a mis-ordered item). Staging lane kiosk 2 may also be optionally equipped with an electronic communications means adapted to allow the customer to communicate with the facility electronically, through voice transmission, audio transmission or a combination thereof.

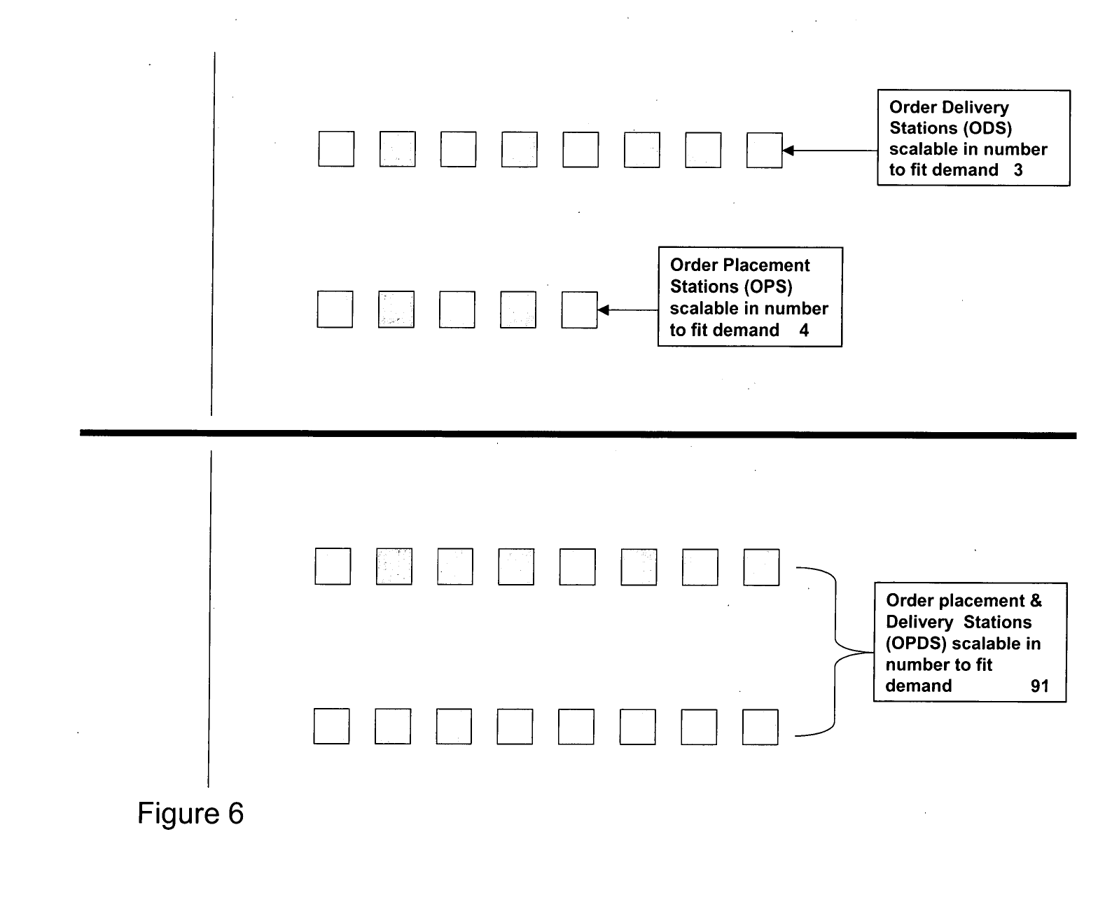

As seen in FIG. 6, after the facility receives the customer's pre-order instructions, if any at all, the facility process may direct the customer to an Order Placement Station (OPS) 4, where the facility will receive orders from consumers for any or all of the classified products or services provided within the facility. The facility process may alternatively direct the customer to a Order Delivery Station (ODS) 3, where the customer may wait for the order to be processed and delivered to the ODS. The goods may be delivered in any number of ways, including by ramp, hook and bar mechanisms, vacuum-type tubes, conveyor systems (including but not limited to conveyor control systems) or any mechanical mechanisms to deliver the ordered ODS and services in a safe and secure fashion. Thus, for example, There could be several types of conveyors employed according to the present invention, including but not limited to; belt conveyors, belt driven live roller conveyor, gravity conveyors, gravity wheel conveyor, tilt tray conveyor, slate wheel conveyor, roller conveyor, minimum pressure accumulation conveyor, minimum pressure accumulation conveyor, vertical conveyor, horizontal conveyor, power & free conveyor, overhead conveyor, skate wheel conveyor, moving slat sort conveyor, crossbelt sorter conveyor, chute conveyors, chain conveyors, car-in-track conveyors or a combination of all the above conveyor systems. Moreover, the present invention contemplates use of available picking technologies, such as Pick List, Radio Frequency (RFID), Voice, RF Carts, Carousels, Pick-to Light, Put-to-Light and A-Frames. The facility 100 may deliver the order to customers in take home totes made from plastic, cardboard, or other molded materials. The take home totes can have imprinted advertising representative of the tenants within the facility or from offsite vendors. The totes may be designed to accommodate pre-bagged and non-bagged products, prepared foods and drinks, dry cleaning, pharmaceuticals, alcohol or hung items in a safe and secure fashion. The totes could be designed to be reusable or made from a paper or inexpensive plastic material the customer picks up and loads directly into the car. It could also be cost effective in some instances to deliver products to the customer's automobile through a reusable material that will occasionally have to be washed by hand or through an automation tote washer.

In another configuration, the facility process may direct the customer to an Order Placement and Delivery Station (OPDS) 91, which may be a combination of the OPS and ODS kiosks. In whatever configuration, each kiosk may be adapted to receive orders from, or deliver orders to, a customer. Thus, for example, if a customer previously placed an order from a remote site (such as the Internet, or through the telephone) and arrived at the facility to pick up the order, the facility process may first direct the customer to the first available OPS 4. Here, the OPS 4 is adapted to receive the customer's order identification number and the facility process will direct the customer to a corresponding ODS 3. Alternatively, if the customer arrives at a staging lane 1 (if provided at this particular location), the facility process may then direct the customer to a corresponding ODS 3 to receive their order. If the particular facility has only OPDS 91 kiosks, then the facility process may direct the customer to the closest available OPDS 91, receive the customer order information, process the order within the structure, and then deliver the order to the customer, all from the customer's same location.

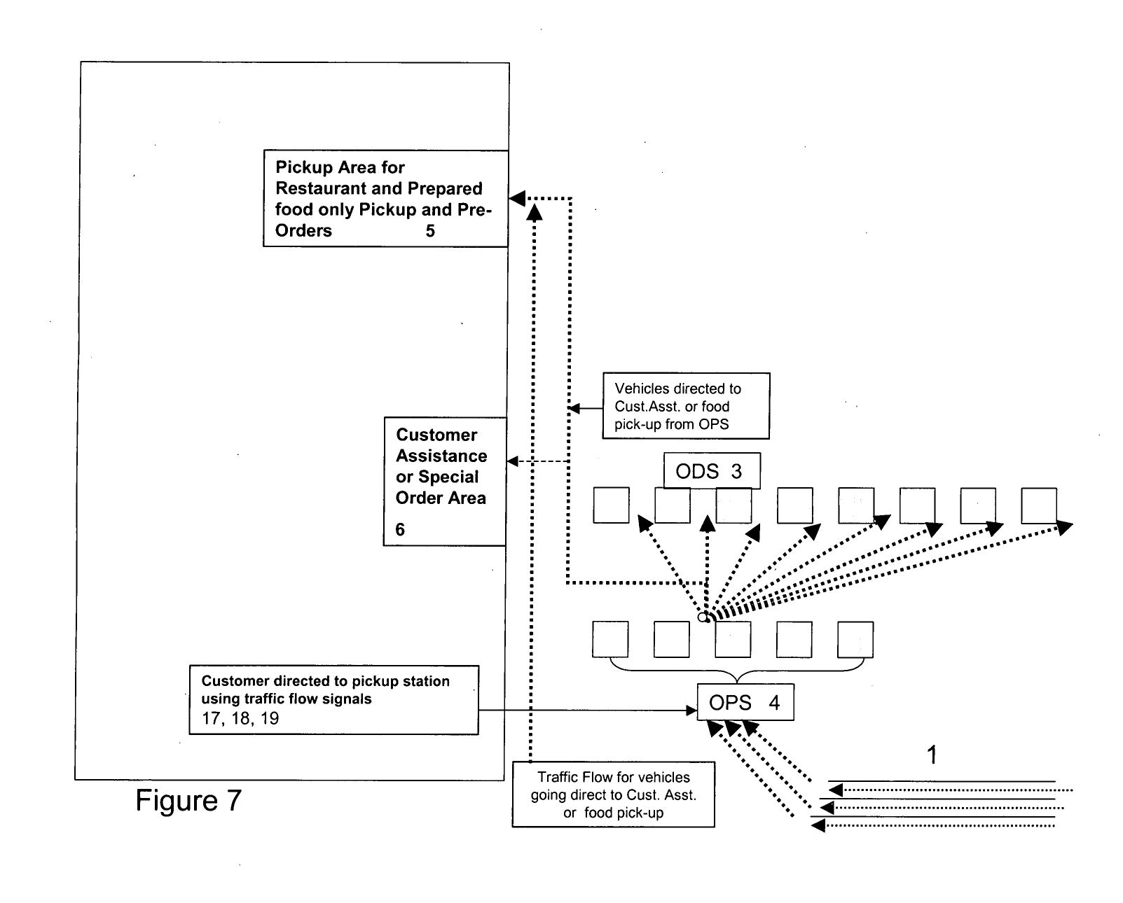

The present invention also contemplates utilizing the features to support the requirements for special needs customers. FIG. 7 depicts an exemplary process schematic when a special needs customer desires to pick up their order. For example, when a vehicle enters the facility whether through an optional staging lane 1, through OPS 4 or OPDS 91, if the customer needs assistance in getting their order into their vehicle due to a personal reason or due to the size of the order or size or sizes of the items ordered, the facility process will direct the customer to a Customer Assistance or Special Order Area 6. Alternatively, if the customer requires only a delivery of pre-ordered food items, the facility process may direct the customer to the prepared food pick up area 5.

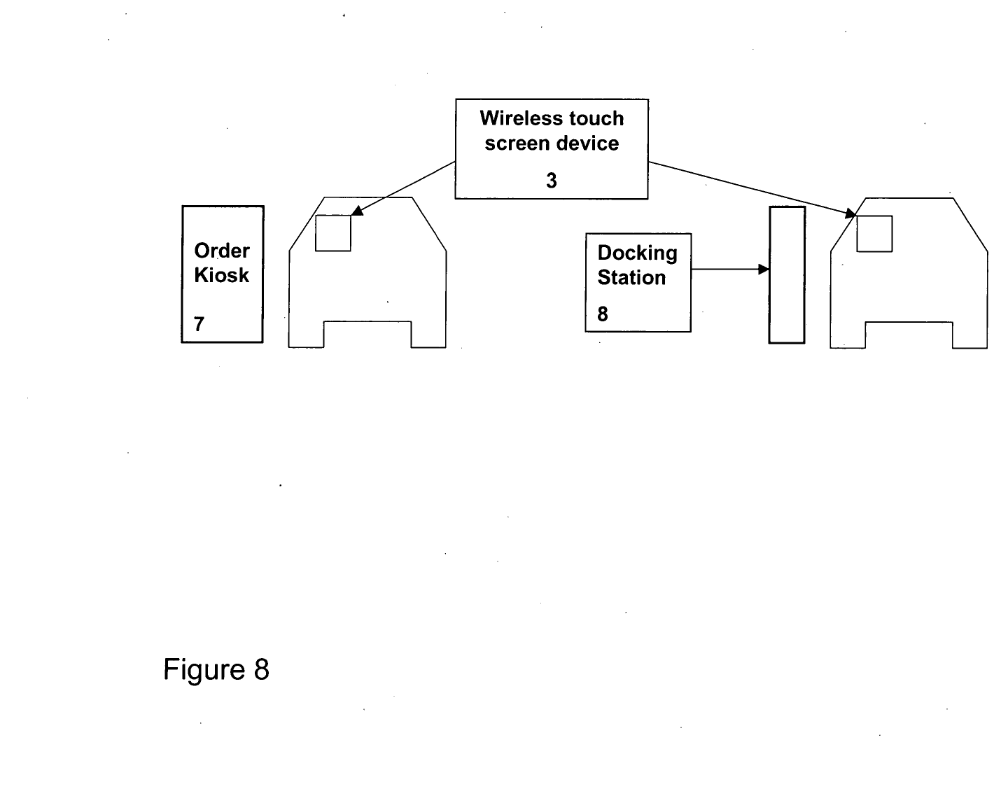

FIG. 8 illustrates a representative situation when a customer enters OPS 4. In this situation, the customer may remove a wireless ordering means 9 (such as a wireless tablet) from either an order kiosk 7 or from a docking station 8 to view items or services available at the facility. The wireless ordering means 9 is adapted to communicate information between the customer and the CORE system, to receive customer instructions for ordering classified goods or services, as well as place orders for items not currently in stock. Those of skill in the art will recognize that the wireless ordering means 9 may also be placed at the pre-ordering kiosks 3 or 4, or at the Customer Assistance Area 6, for the convenience of the customer to place orders, add to an existing order or to check the status of an order.

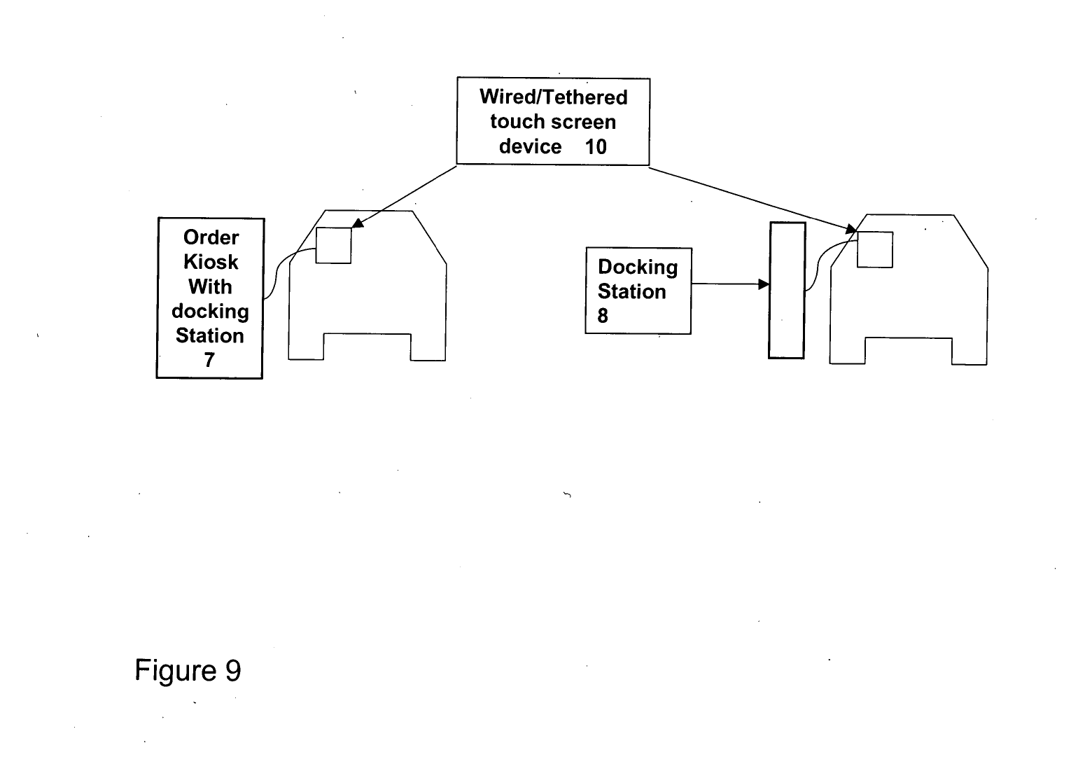

FIG. 9 illustrates another alternative representative situation of how a customer may communicate with the facility according to the present invention. For example, as seen in FIG. 9, the facility process may direct a customer to OPS 4 or ODS 3 where the customer may remove a wirelan or tethered tablet from a docking station 7, the table having an optional touch screen device 10 or other order entry means. The order entry means 10 is adapted to communicate information between the customer and the CORE system, to receive customer instructions for ordering classified goods or services, as well as place orders for items not currently in stock. Alternatively, as depicted in the right side of FIG. 9, a representative wirelan or tethered tablet device 10 may attach to a docking station 8 placed at a staging lane 1, ODS 3 or at the Customer Assistance Area 6, for the convenience of the customer to place orders or add to an existing order or to check the status on an order.

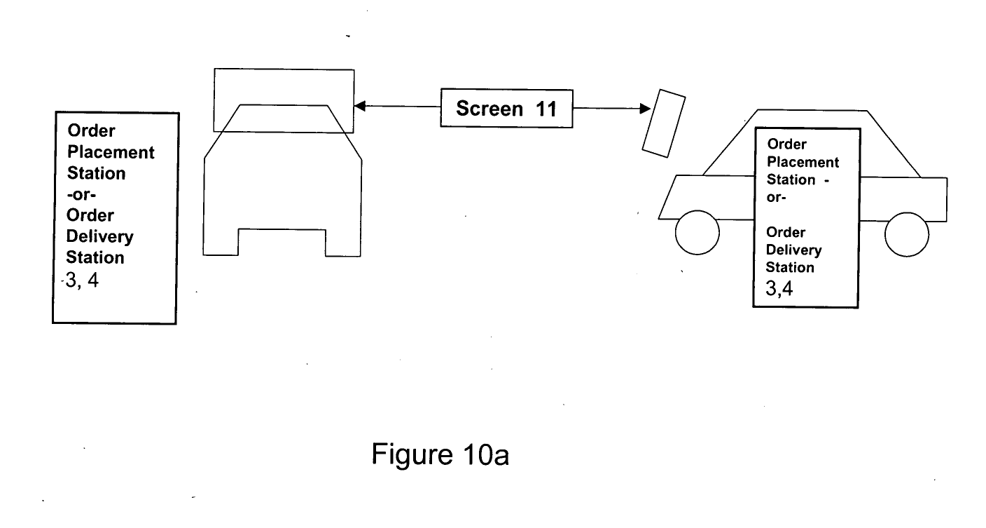

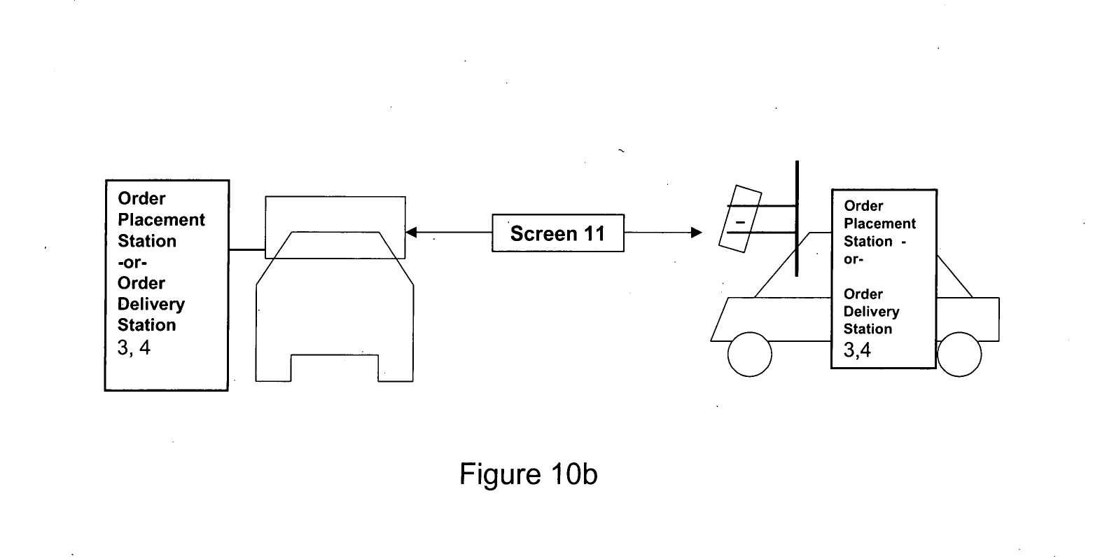

FIGS. 10a and 10b illustrate another alternative situation of how a customer may communicate with the facility according to the present invention. For example, as seen in FIG. 10a, the facility process may direct a customer to OPS 4 or ODS 3, where, upon arrival, the facility process introduces a height-adjustable drop screen 11 (coupled to the facility), which can be viewed by the customer by controlling the screen height to an approximate vehicle window height. The adjustable feature of the screen 11 allows for the screen to move up and down and tilt for the best viewing angle by the customer. The drop screen 11 is adapted to communicate information between the customer and the CORE system, to receive customer instructions for ordering classified goods or services, as well as place orders for items not currently in stock. As seen in FIG. 10b, the drop down screen 11 may also be attached to a kiosk using a pole type device 14 that allows for the screen to move up and down and tilt for the best viewing angle for the customer.

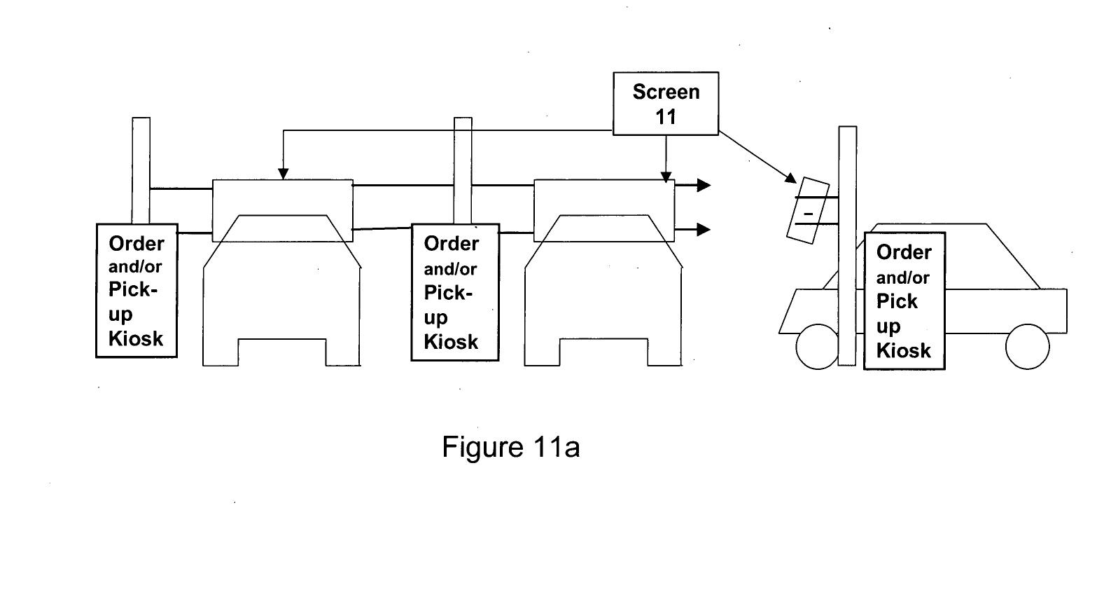

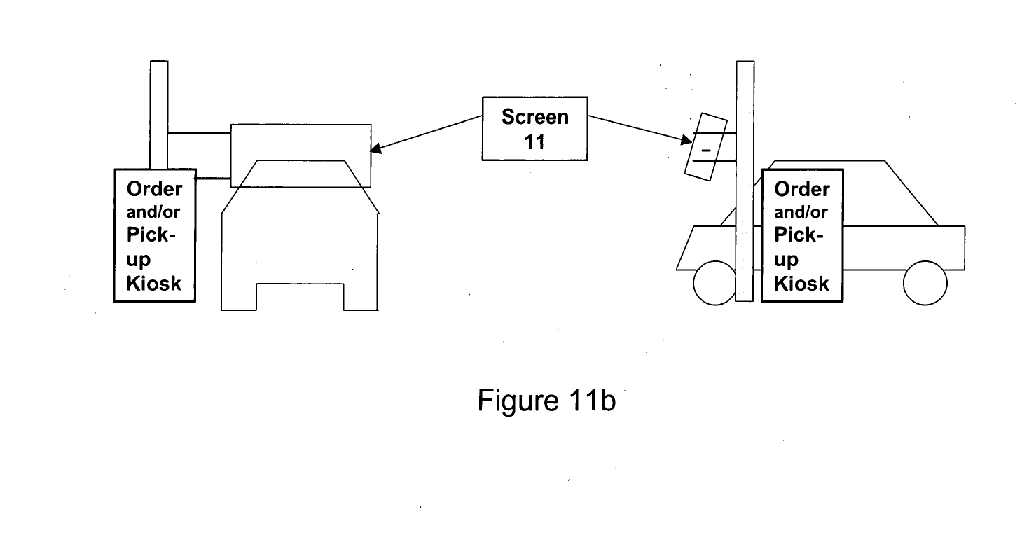

FIGS. 11a and 11b illustrate another alternative situation of how a customer may communicate with the facility according to the present invention. For example, as seen in FIG. 11a, the facility process may introduce a height-adjustable drop screen 11 which is attached between poles 15, the poles being coupled to the facility and being approximately located over the customer's vehicle. This configuration, for example, allows for the screen to move up and down and tilt for the best viewing angle for the customer. As seen in FIG. 11b, the drop down screen 11 may also be attached to a singular pole with a cantilever device 16 located approximately above the customer's vehicle.

Multiple ordering technologies according to the present invention may give the consumer great flexibility and convenience in ordering. Alternative methods include, but are not limited to, walk in, phone in, Internet, drive-thru with touch screen, drive-thru with PDA update. The ordering technologies may also include use a mouse, joystick or laser pointer device in which the consumer directs the curser to the appropriate search tools and products on any order input means. Another device may include a touch screen that is brought into the vehicle. In any configuration, a consumer is in complete control of what products and services they choose to look at or purchase. Moreover, each order input device may include the broadcast of television (conventional, broadcast, cable or satellite) channels including news, entertainment and games. With the same device, the consumer may also communicate with any personnel within facility 100, such as, for example an onsite pharmacist, vendor, or tenant representative if needed, as well as communicate with a representative from each of the vendors or tenants participating at that facility. Other software and communication links employed allow vendor and tenant representatives to be at offsite locations using a 2 way audio or an audio-video transmission. The present invention's CORE system 27 may also allow the consumer to link to the tenant's home website to get product information, special orders and repair/return information and any other information or links provided by the vendor's website. Business intelligence and customer order processing software used within the facility will direct the consumer to other like products if the one chosen is out of stock at that time or if there is a similar item on sale. Once the consumer has concluded the purchase, the device may guide the consumer to various payment options including but not limited to cash, check, credit/debit cards, and travelers' checks. After the transaction is completed and the device is returned, the consumer may then be directed to a specific OPS/ODS or OPDS station(s) to pick up their order.

Moreover, the present invention contemplates the use of holographic imaging so that customers may be able to see the full three-dimensional view of a particular product. Thus, for example, a person from the comfort of their car, home or office, may view a holographic image of themselves wearing the products they are interested in based on the customer's personal information stored within the CORE system 27.

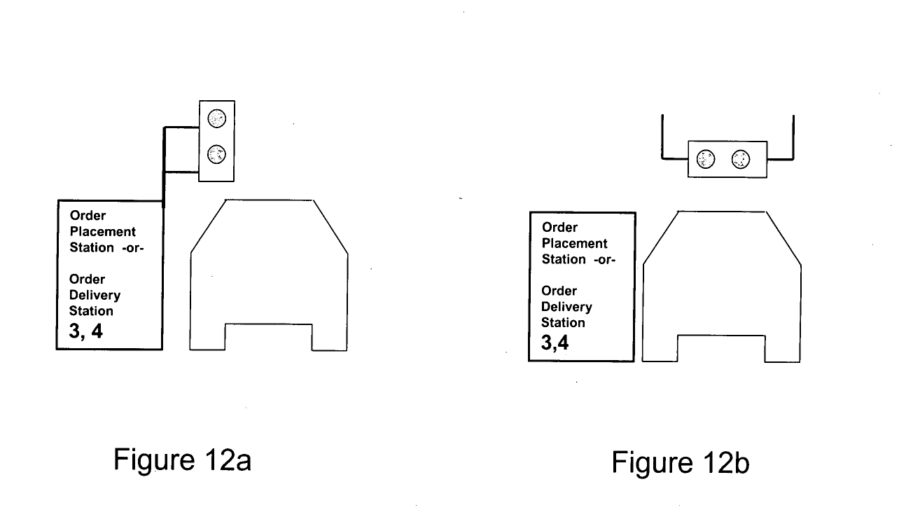

FIG. 12 illustrates a representative graphic of how the facility process controls traffic flow through or within the facility 100 to provide a safe and efficient shopping experience for a customer. In this regard, at least one traffic light system may be attached to each kiosk, preferably through a pole as seen in FIG. 12a, or may be couple to the facility by overhead suspension as seen in FIG. 12b. The traffic light system may either be horizontally or vertically oriented, or may comprise LED lights, light bulbs, and have colors and designs that best fit the need for maximum traffic control. In any embodiment, the traffic light system is preferably placed in a location easily viewed by a consumer. The lights can be standard lights as used in typical traffic light scenarios.

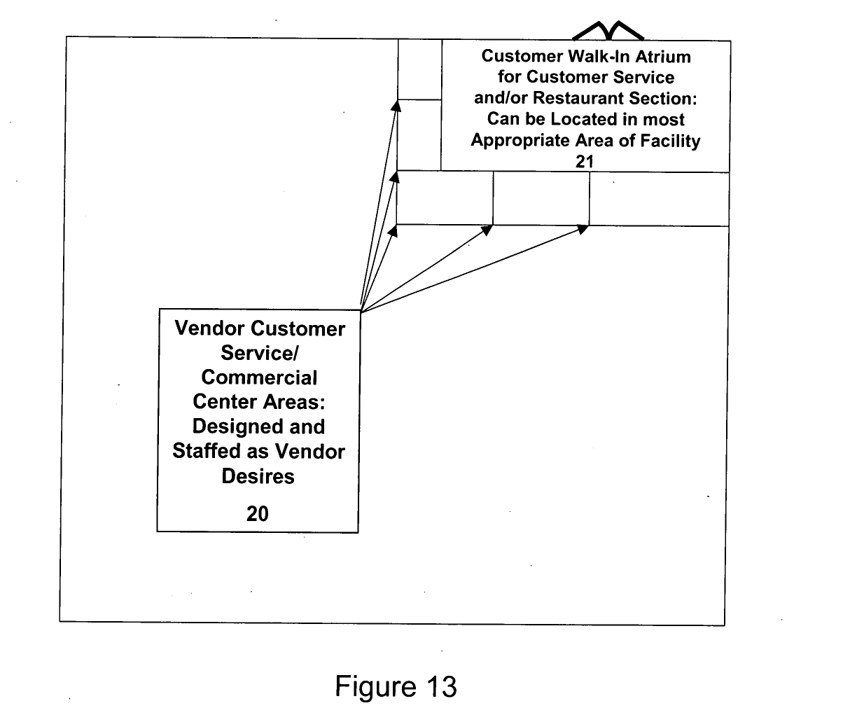

FIG. 13 illustrates a top plan view of a representative interior portion, or walk in portion, which may be integrated into the facility 100 structure. Within each facility, a walk-in portion is preferably defined for the purpose of providing and allowing customer dining in or ordering food from an on-site restaurant tenant. The walk-in portion may also be used to conduct business, or may be adapted to facilitate customer service functions for each tenant within the facility. In one embodiment, the restaurant may be located in an atrium 21 nearest the drive-thru lanes in order to allow for faster delivery of food directly to the vehicle waiting in the ODS 3 or OPDS 91 lanes or at the drive up service window or door exclusively for the restaurant and customer service. In another embodiment, at least one commercial center may be disposed adjacent to the walk in portion and to the atrium 21, each commercial center corresponding to each participating tenant within the facility. This arrangement facilitates the ordering, processing and delivery of classified goods or services which cannot be executed from a vehicle due to government and corporate restrictions (such as, for example, the purchase of liquor or alcohol).

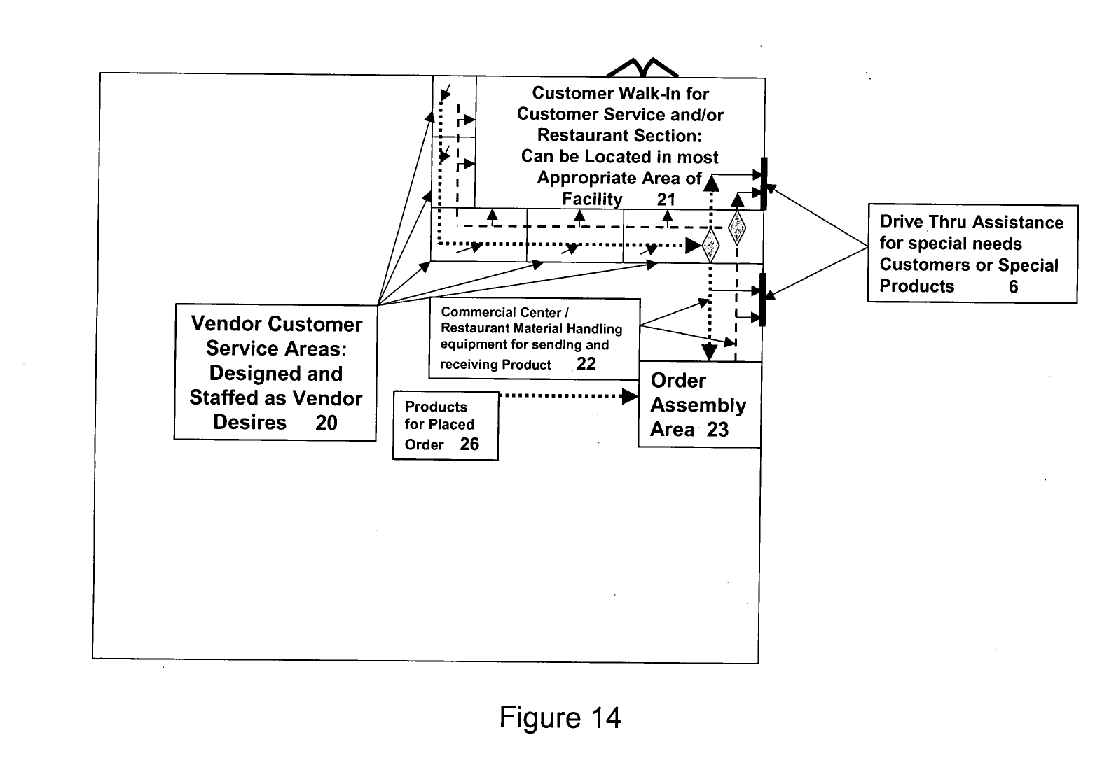

FIG. 14 illustrates another alternative situation of how a customer may communicate with the facility according to the present invention. For example, as seen in FIG. 14, the placement of each commercial center 20 is located to optimize interactions with adjacent drive-thru lanes so that products or services may be provided to a customer within their vehicle. Each vendor's commercial center 20 may be located adjacent to the drive-thru lanes to facilitate communications with individual customers at the OPS 4, ODS 3, OPDS 91, or Customer Assistance Area 6. Such communications may be in person, or may be executed through electronic communication means as disclosed above. Each commercial center 20 is also optimally located for communication with a corresponding product area 26 using a dedicated material handling system 22 which communicates with all tenants within the facility and facility customers. Additionally, the placement of each customer service center (not shown) may be located to optimize interactions with adjacent drive-thru lanes so that returned products or serviceable items may be provided to the facility. Preferably, each customer service center may be located adjacent to the drive-thru lanes to facilitate communications with facility personnel. Such communications may be in person, or may be executed through electronic communication means as disclosed above. Each customer service center is also optimally located for communication with a corresponding product area 26 using a dedicated material handling system 22 which communicates with all tenants within the facility and facility customers.

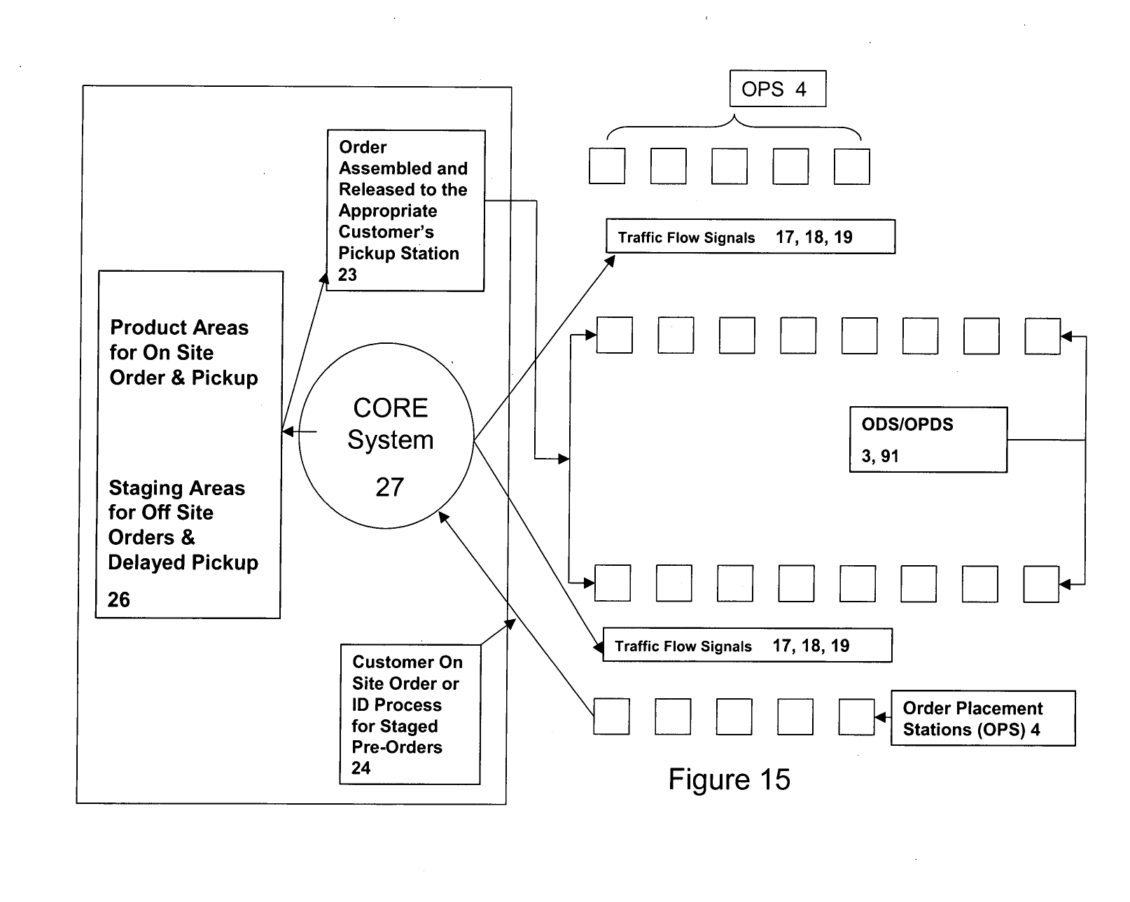

FIG. 15 provides an exemplary operational overview of one aspect of the facility process according to the present invention. When a customer enters OPS 4, the facility process is adapted to accept an order from the customer, or, to process an order previously placed by the customer (such as, for example, through the Internet). Some element of OPS 4 (such as the touch screen order input means described earlier) is adapted to provide communication between the customer and the CORE system 27. The CORE system may be adapted to fulfill order based on order time sequencing in which all goods are services are processed for delivery to the consumer in an optimized fashion. For example, the CORE system 27 will estimate the delivery time based upon the preparation of each classified good or service ordered, communicate the estimated time to the consumer, starts the sequence of preparation or picking of each classified good or service in order to optimize the quality of such goods or services when delivered to the consumer.

The CORE system 27 may also adapted, in one aspect, to manage, control or otherwise operate a materials handling system (not shown) which is adapted to transport materials (i.e., classified goods and serviced items) throughout the facility 100. Thus, in one example, the materials handling system may be integrated into a product area 26 to facilitate the control, storage and transport of classified goods or pre-ordered good to an order assembly and consolidation area 23. The CORE system is also adapted to confirm that the good ordered corresponds to each correct customer at the order assembly and consolidation area 23 and will release the order to the appropriate ODS 3 or OPDS 91. For staged orders communicated through kiosk 4, the customer may communicate a customer ID to the order entry system, or may use a electronic device such as, for example, a Speed Pass Device 24 that will alert the CORE system 27 of their arrival at the facility so it can release their order for delivery. A representative pickup portal area may also comprise a pressure controlled product delivery system. Due to the wide variety of products offered within the facility 100, a pressure controlled drawer may be used to deliver a wide variety of appropriately sized products from all the tenants and vendors contained within the facility and this could include food items.

In another example, the CORE system 27 is adapted to manage the inventories by monitoring inventory levels and reordering when needed the depleted products. This reorder feature may be used to order the inventory from, for example, any site the tenant controlling that product wishes, the manufacturer, a wholesaler, a distributor, another store belonging to the tenant or a reorder request sent to the tenant's own purchasing department. The CORE system 27 may also constantly update the inventory as to the needed inventory on hand, the pricing and even the inventory's location within the facility if it's been moved to a new zone due to volume of sales. The CORE system 27 is also adapted to track availability of inventory and provide alternative item option to the consumer if applicable. Once a consumer has completed an order, the CORE system will, in a coordinated effort, systematically control each product on the order from its proper zone in the proper sequence to maximize the personnel assembling the order to facilitate the fastest response time possible. In the case of an offsite order, the same process takes place however the order will be put in the appropriate staging area or areas depending on product sensitivities within the order.

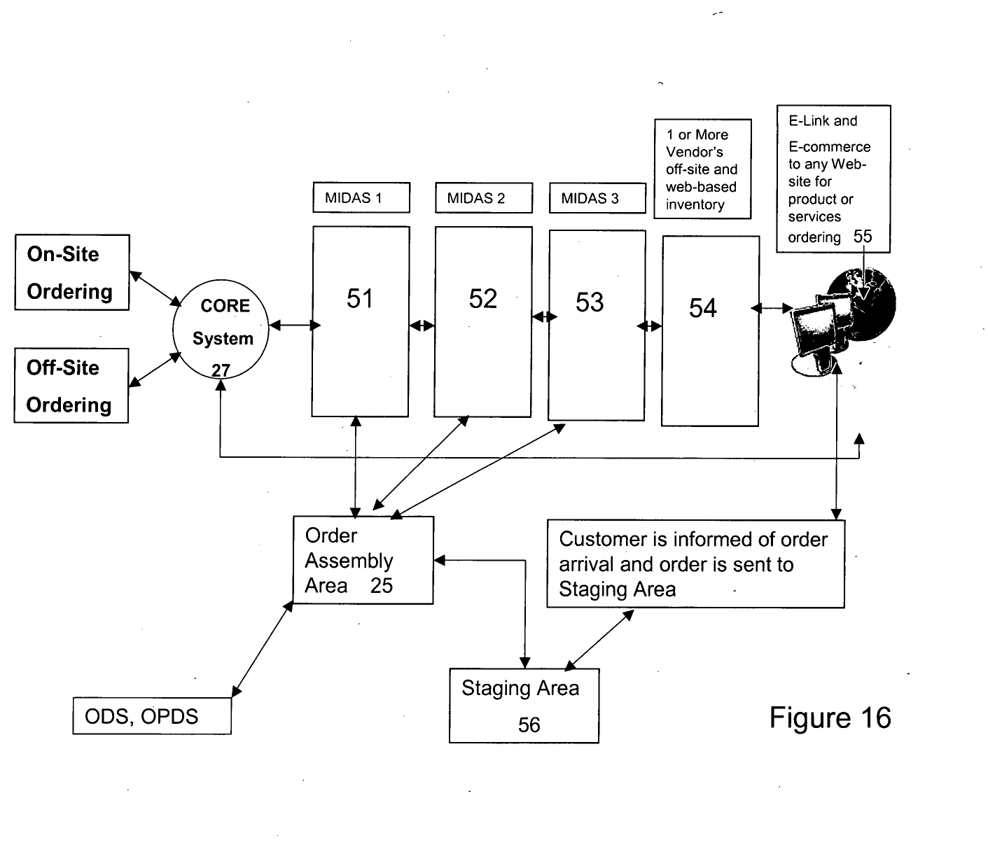

FIG. 16 depicts an illustrative flowchart identifying several features of the CORE system 27. In one preferred embodiment, the CORE System 27 comprises at least one computer system which operates the facility as a retail facility, and may be realized in the form of one or more electronic, computer, software, hardware or mechanical based systems, or any combination thereof. The CORE system 27 includes enterprise resource planning software for the management of each SIC or NAICS goods and service classification requirements. DRWMS 28 is adapted to dynamically control most, if not all, of the physical functions of the facility 100 from communicating with customers, obtaining orders, processing the orders by, for example, picking the ordered products, assembling and subsequently delivering the orders to the customer's vehicle.

The products or SKUs according to the present invention are stored in the appropriate, pre-selected area, which may depend on demand and depth of inventory for that product. As demand for a certain SKU changes, the location of that particular SKU may also change within the facility. Thus, in one embodiment of the present invention, the facility structure 100 is adapted for storage of tenant goods in at least one area, and preferably at least three areas, for efficiency in order processing. For example, the first area defined as the Maximum Inventory Demand Area Storage (MIDAS 1) 51 may be adapted to store those classified goods which are have the highest customer demand (e.g., high turnover, or high processing rate which requires increased inventory replenishment). The MIDAS 1 storage area will facilitate storage for classified goods offered by one or more tenants within the facility 100. The second area may be defined as the Medium Inventory Demand Area Storage (MIDAS 2) 52, which is adapted for storing those classified goods that are frequently purchased and should be in stock, but can be stored in an area that doesn't interfere with the highest moving items and can be picked in an efficient manner when ordered. Similar to the MIDAS 1 storage area, the MIDAS 2 storage area will facilitate storage for classified goods offered by one or more tenants within the facility 100. The third area may be defined by the Minimum Inventory Demand Area Storage (MIDAS 3) 53, which is adapted for those items that the CRM 40 program determines are purchased by an existing customer base but done so at a less frequency than the items contained in the other two areas. In one exemplary embodiment, the classified goods stored in the MIDAS 3 area could be stored in convenient areas near the other two areas and may include static shelving or other types of storage means to handle the product storage demands in a way that is both functional and cost effective in relation to the slower moving items contained within this facility. Those of skill in the art will come to realize that the CORE computer system may, as part of inventory management, rotate the storage areas MIDAS 1, MIDAS 2 and/or MIDAS 3 for speed of delivery as needed.

In any embodiment, the CORE system 27 is adapted to communicate with and control the contents of each storage area 51, 52, 53 or 54. This way the most common products are segmented together and are not being stored with the less demand products. This enables the personnel within facility 100 to greatly increase the number of product choices without sacrificing order delivery speed from the most popular high selling products. Another embodiment of the current invention is that by segmenting the inventory by demand area, it allows a greater inventory mix at a lower cost for the vendors.

As further illustrated in FIG. 16, the present invention may offer each customer the ability to order from any e-commerce site (even if not related to any of the tenants within facility 100) and have the order shipped to the facility. Once the e-commerce order is received, the facility process will notify the customer, and the goods ordered may then be sent to the assembly area 25 and dispatched to appropriate ODS 3, or OPDS 91 for immediate pick-up by the customer, or it may be sent to a staging area 56 for later pick-up.

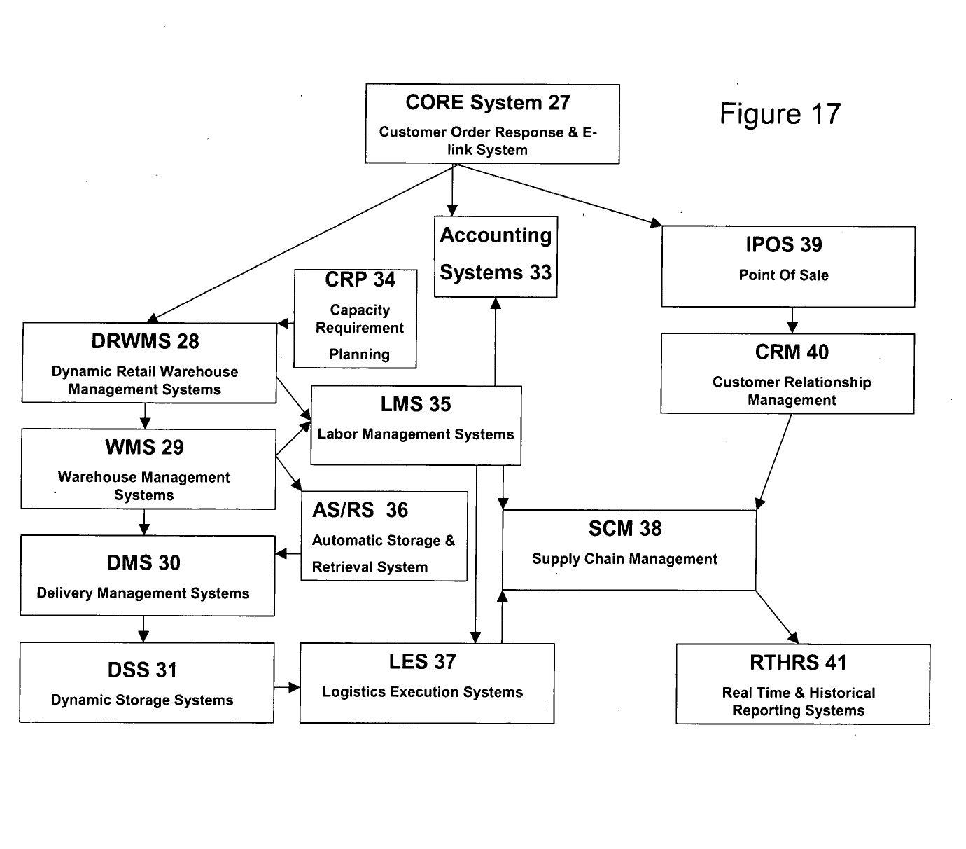

In one embodiment as depicted in FIG. 17, the CORE system 27 comprises at least a first segment, a second segment and a third segment. The first segment may be the Dynamic Retail Warehouse Management System (DRWMS) 28, which tracks, maintains, operates and controls the entire ordering process, from order entry to final delivery to a customer. The second segment may be the Point Of Sale system (IPOS) 39, which is adapted to communicate with the DRWMS and the customer for order entry and confirmation. The third segment may be an accounting system 33, which handles all the financial implications from both the tenant(s) and the customer, and is adapted to communicate with the DRWMS and the POS.

As seen in FIG. 17, the DRWMS 28 may also communicate with a Warehouse Management System (WMS) 29 which is adapted to manage facility personnel, inventory, and equipment related to picking and processing and consolidating a customer's order. The WMS 29 is also optimally adapted to coordinate all warehouse functions, control smaller systems and determine the pick and flow of ordered products as known to those of skill in the art. In one process, the WMS 29 may be given the parameters for all the products currently available within the facility from a Capacity Requirement Planning system (CRP) 34. The CRP 34 is designed to determines the number of stock keeping units (SKU) based on size, weight, and sales flow that fit within a particular material handling section. The WMS 29 then communicates this information to the Delivery Management System (DMS) 30, which can then track and process the order for delivery to a specific delivery station.

The DRWMS 28 may also communicate with a Dynamic Storage System (DSS) 31 which is adapted to operate and control the mechanical movement of product. In one preferred embodiment, the DSS 31 is optimized to increase storage density and storage and retrieval and order picking throughput. DSS 31 is also adapted to communicate with a Logistics Execution System (LES) 37 which is designed to optimally coordinating the location of the picking process, and well as the scheduling of the picking process so as to optimize the order picking process and thereby maximize the labor load as peak and slow loads occur. This process function is controlled by the AS/RS 36, Automatic Storage and Retrieval System (AS/RS) 36. In one embodiment, the AS/RS 36 may be a process which controls and maintains inventory data, may be adapted to control the pick and flow rack, and may adapted to receive and replenish inventory as directed by the CORE system 27.

Thus, for example based on the foregoing discussion, the WMS 29 may be given the parameters for all the products within the facility from the CRP system 34, which determines the number of SKU's based on size, weight, and sales flow that fit within a particular material handling section. With this information, the WMS 29 controls the DMS 30 that determines pick and flow of products. The DSS 31 provides for the mechanical moving of product so as to increase storage density and storage and retrieval and order picking through put.

Accounting system 33 is adapted to control all financial aspects of the present invention, including providing all payment options and completing financial transactions with customers and maintaining finance data pertaining to each tenant within the facility 100. In one embodiment, the accounting system 33 is adapted to communicate with a Labor Management System (LMS) 35 that communicates with the WMS 29 and the LES 37 to appropriately record and maintain labor data, including compensation. The accounting system is also adapted to communicate with the LES 37 to receive and store accounting information relating to items picked.

The CORE system 27 is also adapted to provide full accounting information and processing to each tenant within the facility. For example, the CORE system 27 may be adapted to provide sales volumes, electronically deposit funds to each vendor's specified account, invoice tenants based on contractual arrangements and provide profit margins per product information (thereby allowing for a constant update of the product mix to maximize profitability for all involved in the particular facility). The CORE system 27 can be adapted to provide to the facility management and each participating vendors a full compliment of financial reports at every appropriate timing daily, weekly, monthly, quarterly, and annually. The Accounting System 33 is also adapted to obtain information relating to a single consumer order and correspondingly distribute the funds and all local and federal taxes and fees to each facility tenant represented within the order.

In another embodiment, the Accounting System 33 is adapted to invoice each tenant an appropriate amount for each order handled. The system 33 is also adapted to electronically deposit within each tenant's designated account the proper remuneration for all products or services vended. The Supply Chain Management (SCM) 38 is adapted to communicate date from the LMS 35, the LES 37 and the Customer Relationship Management (CRM) 40 to make sure all the correctly ordered items are kept in a particular facility based on customer demand and frequency. SCM 38 is also adapted to schedule shipments to arrive in a particular order so that the facility is replenished in a way that will maximize supply chain logistics based on demand and throughput.

The Interactive Point of Sale system (IPOS) 39 is adapted to communicate with customers to receive orders, to transmit instructions, or otherwise communicate with customers during an order or delivery process. Thus, for example, the customer may communicate with the IPOS system via any type of wireless device, cellular, microwave, 802.11x, Bluetooth, satellite or any other wireless protocol, whether while at the facility or at a remote location. The customer may also communicate with the IPOS 39 through a wirelan communication protocol such as a telephone, handheld devices, onsite communication devices, point device, touch device, personal computers or through a combination of hard-wirelan and wireless networks such as may be found on the Internet.

IPOS 39 may comprise a graphical user interface for ease of use by the consumer. IPOS 39 may also include a purchasing option that provides a customer with all forms of electronic payment and may offer the ability for the customer to process or order gift cards, coupons, and credit options as well. The IPOS 39 is also adapted to transact financial matters in the form of check or case for any on-site financial transactions. In another embodiment, IPOS 39 is adapted to communicate with each tenant's computer systems or inventory management systems (such as, for example, to a tenant's website) to attain more information on classified goods or to place an order for classified items not stocked in the facility. The IPOS 39 is also optionally adapted to store customer information based on each sale within the facility.

The IPOS 39 as seen in FIG. 17 may also include a Customer Relationship Management system (CRM) 40 adapted to store data relating to each customer's inventory of ordered items, the customer's buying trends, special dates, customer's preferred sizes, and all other customer-specific information needed for a full retail understanding of each customer. The CRM 40 may also be adapted to retain customer financial data, such as credit card information, debit card information and other payment information so that the customer can select their choice with each subsequent purchase. In this regard, the SCM 38 may then communicate such customer financial information to the Real Time and Historical Reporting System (RTHRS) 41. RTHRS 41 is adapted to store information and be disseminated to the tenants within the facility on a real time or historical basis. The RTHRS may also be used to generate reports for each customer thereby allowing a customer to view their own buying trends and other information specific to their account.

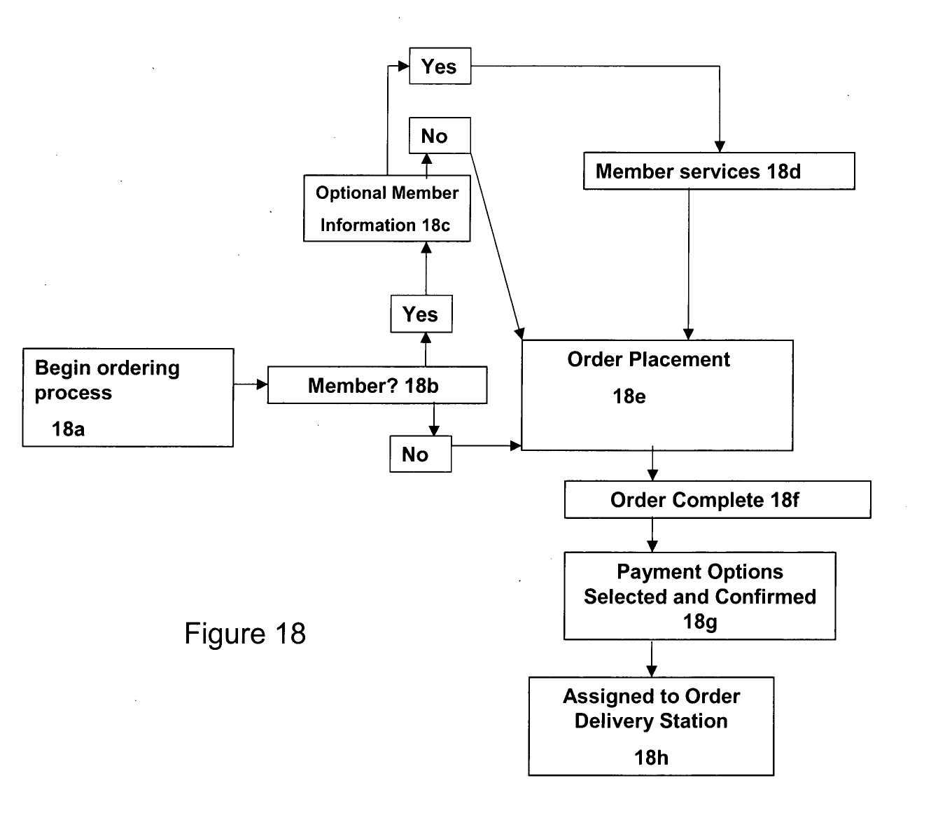

FIG. 18 graphically illustrates a representative on-site order process. When a customer arrives at the facility 100, the facility process will initially question whether the customer has a membership at the facility (step 18a). If the customer is not a member, the facility process will take the customer to the order screen for receiving the customer's order (step 18e). If the customer is a member, the facility process will optionally proceed to display historical customer purchase information (such as displaying previous orders) through a member services screen display (steps 18c and 18d). Some of the displayed information may include a personal inventory where all the purchases bought by the client will store in the data base so that the client can see what they purchased, how often, how much, and at what price. They can check on specials, hardcopy or electronic coupons and promotions, receive pick-up notices on items that have arrived since their last visit, see if they qualify for any member awards or coupons. If the member chooses to they can by-pass the member services section go directly to the order screen (step 18e). During order placement, the facility process is adapted to receive communication from the customer (step 18e). As stated previously, the ordering instructions may be received from the customer by an order input means such as a wireless tablet, or via a drop down screen. Similarly, other communications may take place during step 18e as may be desired. Once an order is received, finalized and payment is processed (steps 18f and 18g), the facility process will then instruct the customer to proceed to the appropriate ODS 3 or OPDS 91 (step 18h) for order delivery.

Membership at the facility may provide an added convenience factor for consumers. For example, a membership based facility may provides frequent customers the opportunity to pay an annual fee to be members. This membership will allow each participant to get early sales notification of products and services they regularly use they will get freeloader coupons for product and services. The members will know of product changes before it actually happens and other similar information sent out regularly via e-mail to all members. As another example of membership benefits, PDA or handheld ordering devices may be provided to members and programmed specifically for members to alert them of any membership events, promotions, electronic coupons, price changes, specials, new products or other processes. These wireless devices may be programmed to include the entire content of products and service offerings available at the facility 100. A bar code wand or RFID could optionally accompany such handheld devices and will allow customers to manage their personal product and service needs. Such portable devices may be programmed to allow entry of consumer information and consumer preferred product information. Then, for example, when a customer throws an empty can of Del Monte Green Beans away, the consumer may scan the can's bar code so that the portable device continually stores a listing of needed products and services which may need to be ordered upon the next visit to the facility. Through wireless or wirelan technology, a customer may then be notified of their order being ready.

As described briefly above within step 18d of FIG. 18, but more fully discussed here, many exemplary information services may be offered to a customer according to the present invention, whether while the customer is at the facility or through other communication means (such as, for example, through the Internet). For example, personal inventory data may be available which maintains data related to all purchase information made by the customer (e.g., what was purchased, how often, how much and at what price). Promotional information may also be communicated to customer, such as specials, discounts, coupons, membership award points, available membership awards and related promotions.

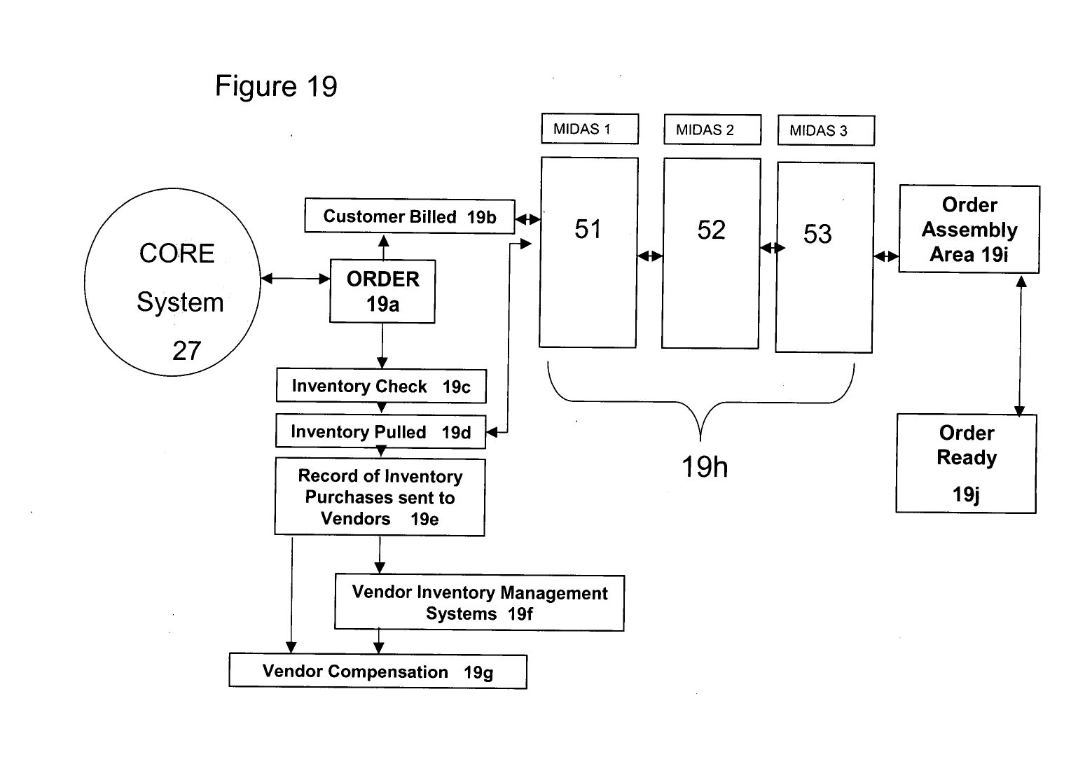

FIG. 19 illustrates an exemplary flowchart depicting order processing by the CORE system 27. Once an order is received by the facility process (step 19a), the customer is invoiced (step 19b), and the CORE system 27 verifies availability of the inventory (step 19c). If the inventory is available, the system 27 proceeds to obtain the classified good or service item (step 19d). The system 27 then records the order and sends the order information to the corresponding tenant (step 19e). The CORE system 27 then communicates with the tenant's Vendor Management System 60 (step 19f), which reacts to new classified goods arriving to replace or change the inventoried items sold. The CORE system 27 also forwards the appropriate compensation to the tenant in a fashion selected by the vendor (step 19g). The system 27 then obtains the ordered classified goods from the proper storage area (e.g., MIDAS 1, MIDAS 2, MIDAS 3) known by system 27 (step 19h), sent to the Order assembly and consolidation area 23 (step 19i), and then delivered to the customer waiting for immediate delivery or sent to the Staging Area for later pick-up (step 19j).

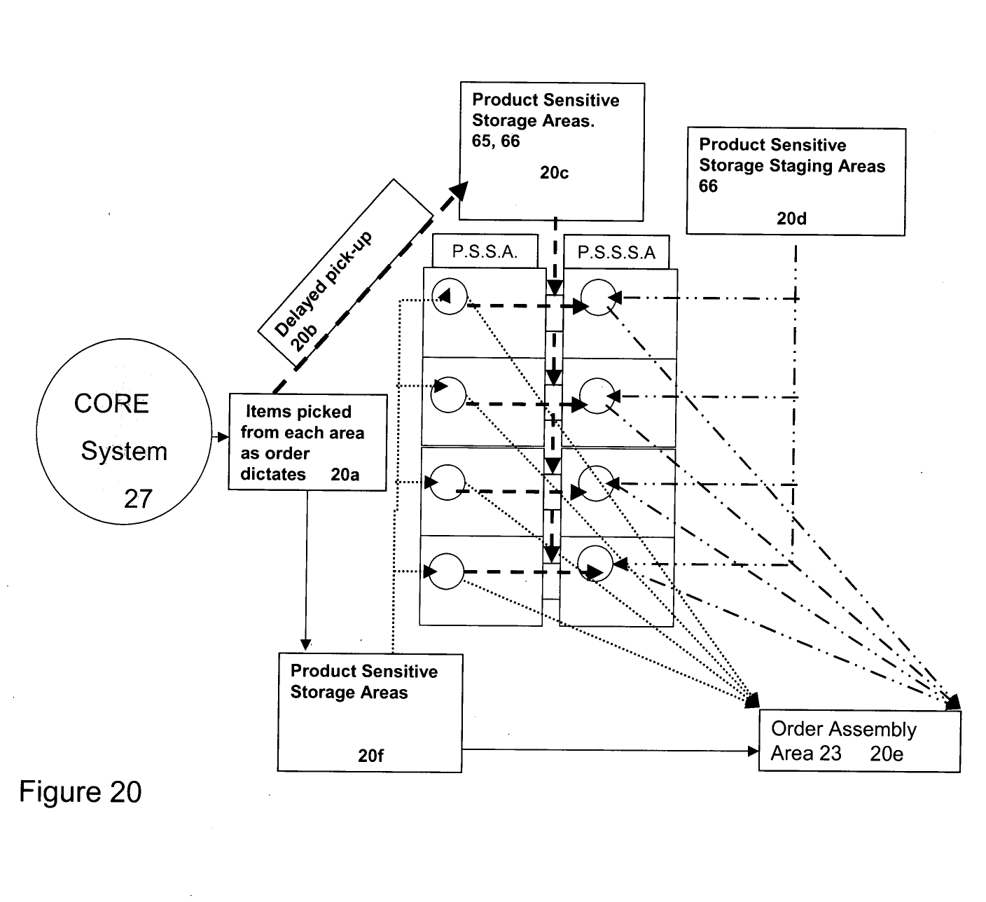

FIG. 20 illustrates an exemplary flowchart depicting classified goods and serviced items storage processing by the CORE system 27. In one aspect of the present invention, certain pre-specified classified goods and serviced items may be stored within an appropriate climate controlled area as required which may be operated, maintained or otherwise controlled by an appropriate product sensitive control system (hereafter referred to as Product Sensitive Storage Areas, or, PSSA 65). Those of skill in the art will realize that the product sensitive control system may be realized in the form of one or more electronic, computer, software, hardware or mechanical based systems, or any combination thereof, and adapted for communication with the CORE system 27. Thus, for example, certain portions of the facility 100 may be adapted to store or house frozen goods, meat good, produce goods, and dairy goods. The PSSA is in communication with all defined tenant stored goods areas (such as, for example, MIDAS 1, MIDAS 2 or MIDAS 3 areas) and is also in communication with all defined staging areas within the facility 100.

In one exemplary embodiment as generally depicted in FIG. 20, when the facility process receives an order containing a sensitive good through the CORE system 27, the CORE system 27 directs the appropriate product sensitive system (not shown in FIG. 20) within the PSSA 65 to retrieve the ordered good (step 20a) for subsequent transmission of the good (step 20f) to the Order assembly and consolidation area 23 for dispensing to the customer (step 20e). However, there may be instances when the order received by the CORE system 27 is not to be delivered to the customer until the customer provides instructions to do so (such as, for example, if the customer placed the order over the Internet, and must travel to the facility to pick up the order). In these situations, the CORE system may direct the appropriate product sensitive system to retrieve the ordered good (step 20a), and forward the good for delayed retrieval processing (step 20b). For example, the facility 100 may be compartmentalized into and include at least one sensitive product area for receiving, storing and transporting special goods or serviceable items which require certain environmental controls in accordance with the product's storage and inventory requirements. Thus, for example, representative controls may include, but are not limited to, humidity controls, product rotation controls, expiration controls, heat controls, refrigeration controls, ambient temperature controls, dry goods handling controls, special handling controls, packaging controls, secure access controls, consolidation and bagging controls and air circulation controls.

The CORE system may then directs the ordered good to be then sent to the PSSA 65 for short term storage (step 20c). In one embodiment, for example, the PSSA 65 may include a single or compartmentalized carousel to hold goods for a short time for pre-order goods or for time-sensitive goods (e.g., frozen goods, refrigerated, heated, dry goods, humidity controls, or to provide a method for a customer to pick up a controlled product). When the customer arrives, the CORE system then directs the ordered sensitive good to be forwarded to a Product Sensitive Storage Staging Area (PSSSA) 66 (step 20d), where the good and other goods are prepared for delivery to the customer. Orders placed before pick-up time will be preferably held in the staging areas within the appropriate areas of the facility 100 to assure protection and freshness of the products ordered until the products are to be picked up at the customer's convenience. When ready for delivery, the CORE system directs the good (or goods) to be delivered to the Order assembly and consolidation area 23 for retrieval by the customer (step 20e).

The present invention also contains unique qualities in how it facilitates communication between the participating tenants. For example, the present facility is intended to house several diverse retailers and service providers (e.g., tenants) that will share the complex's unified operational order processing and delivery system. The shared services, like facility maintenance, grounds maintenance, personnel or staffing, shipping or delivery bays, utilities, telecommunications, and security which are common in a retail setting, will be much lower than in any traditional retail setting because such services will be shared amongst the participating tenants. Moreover, additional shared services include customer order processing, delivery fulfillment, completion and verification, communication, inventory control management, tracking, returns, and full accounting and reporting to all corresponding tenants. The tenants, according to the present invention, also gain the advantage of use of other shared services, including centralized order entry, order processing, order delivery, and shared stocking and picking, centralized accounting and centralized inventory management system, all for the benefit of the tenants. Another tenant advantage of the present invention is that it reduces or otherwise eliminates theft or shrinkage of products. The present invention also substantially reduces the costs of equipping and maintaining the pedestrian sales floors for each tenant, and the common area maintenance internal to most pedestrian malls. The present invention may also reduce the number of employees required by a conventional retail mall vendor for cashiering, sales help, floor restocking and clean up, by reducing or eliminating the need for these functions. The present invention also reduces the number of employee “touches” on every product, greatly reducing handling costs. With the advanced technology contemplated in this invention, customers will have a full audio or audio/video link to vendor or tenant representatives of the SIC/NAICS product or service classification of their choice, giving them a level of service and interaction unlike any existing retail format.

Some of the additional benefits of the consolidated features of the present invention include reduced operational costs through consolidation, the benefit of drawing from a considerably larger customer base than any stand-a-lone retail store or outlet, reduced operational costs by sharing employees, sharing a common Warehouse Management System(s), common facility and warehouse space, and sharing information systems.

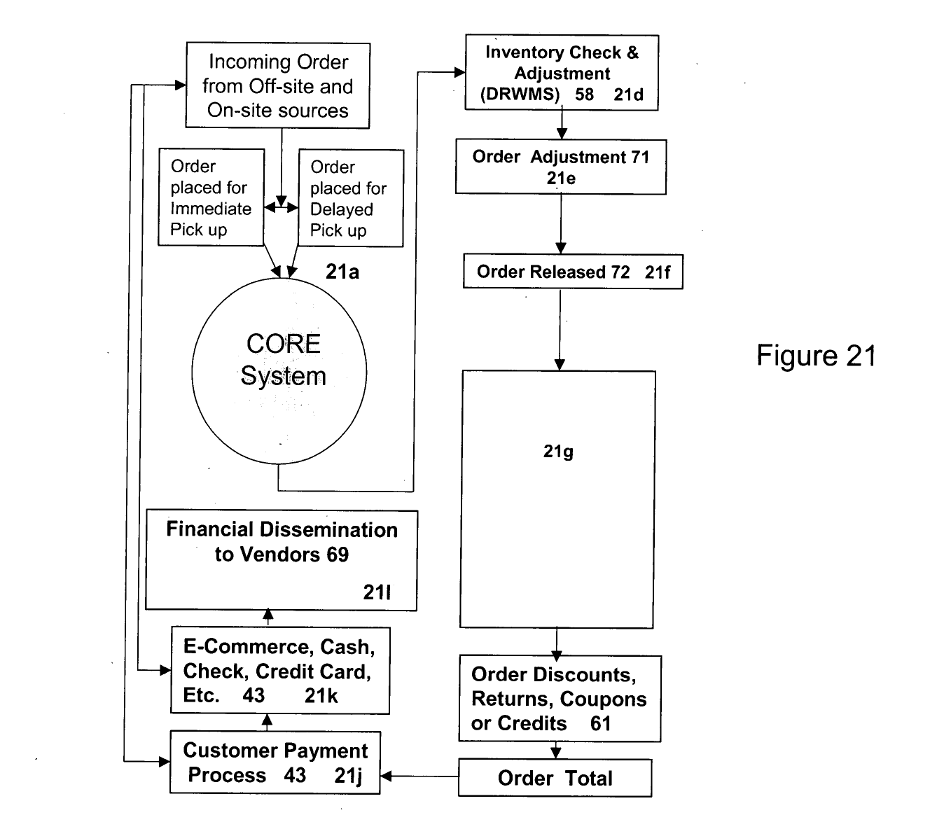

FIG. 21 illustrates a representative Order Response process 70. Once the order is received by the facility process (step 21a), the CORE system 27 verifies availability of the inventory (step 19c). If the inventory is available, the system 27 proceeds to inform the customer of the availability (step 21d). If the good is has been replaced with a similar good, the CORE system 27 may offer the customer the choice of keeping the new good, exchanging it for a different good, or allowing the customer to back order the good for later delivery through an Order Adjustment process (step 21e). Once the order is confirmed as being completed, the order is released (step 21f) which directs the DRWMS 28 to begin the picking and assembly process. During this time, the system 27 checks for any additional transactions or services involving the particular customer, such as, for example, parcel received, dry cleaning ready, movie DVD requested is now available and other similar functions. The system will also process any additional transactions such as back order processing, Internet order processing and off site order processing, and add all the additional transactions to the order for processing (step 21g). Once the CORE system 27 has completed the order including all ancillary charges for the additional items, all discounts, credits, coupons or promotions (step 21h) will be added in to the total price giving the final Order Total (step 21i). The CORE system 27 is then adapted to receive payment from the customer using any conventional payment option, including e-commerce, cash, checks, credit card, debit card or gift card (step 21k). At completion and confirmation of payment, the Accounting System 33 gives the appropriate Financial Dissemination 69 to the proper tenant (step 21l).

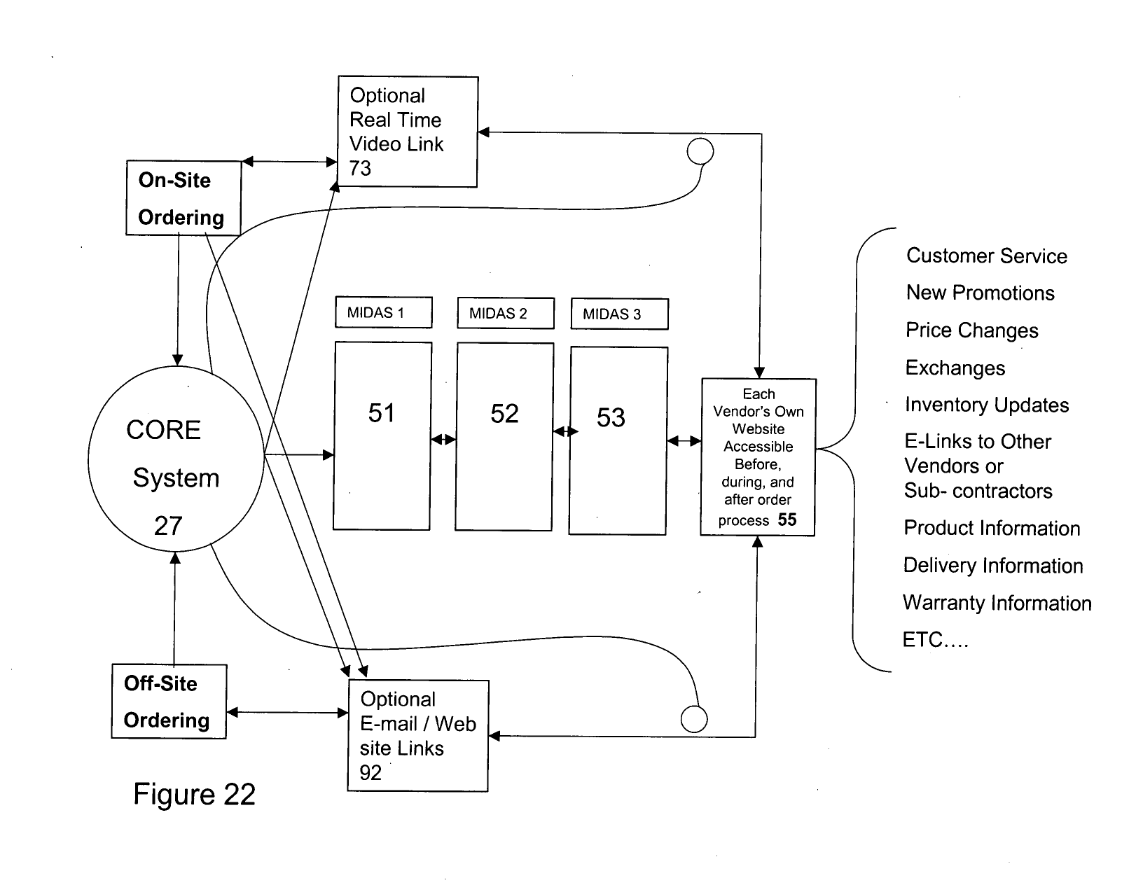

According to the present invention, a customer is not limited to the classified goods and services available at one facility 100. As seen generally in FIG. 22, the CORE system 27 may be adapted to communicate with similar remote systems to check the inventory at other facilities and have selected items held for later customer retrieval, shipped to the next closest facility, or order the goods for retrieval by the customer at a different location. The CORE system 27 may also be adapted to allow remote customer communication (such as, via an optional audio/video device) from one facility to another facility. Thus, the present invention contemplates consumer communication with other facility data or personnel. The CORE system 27 may also be adapted to allow the customer to access another computer network such as the Internet, and may allow for transmission of electronic mail communications. These features provides great flexibility for a customer, and allows a customer to order for another office, co-worker or emergency need at another location and be in control of the purchases, whether at a local facility or a remote facility.

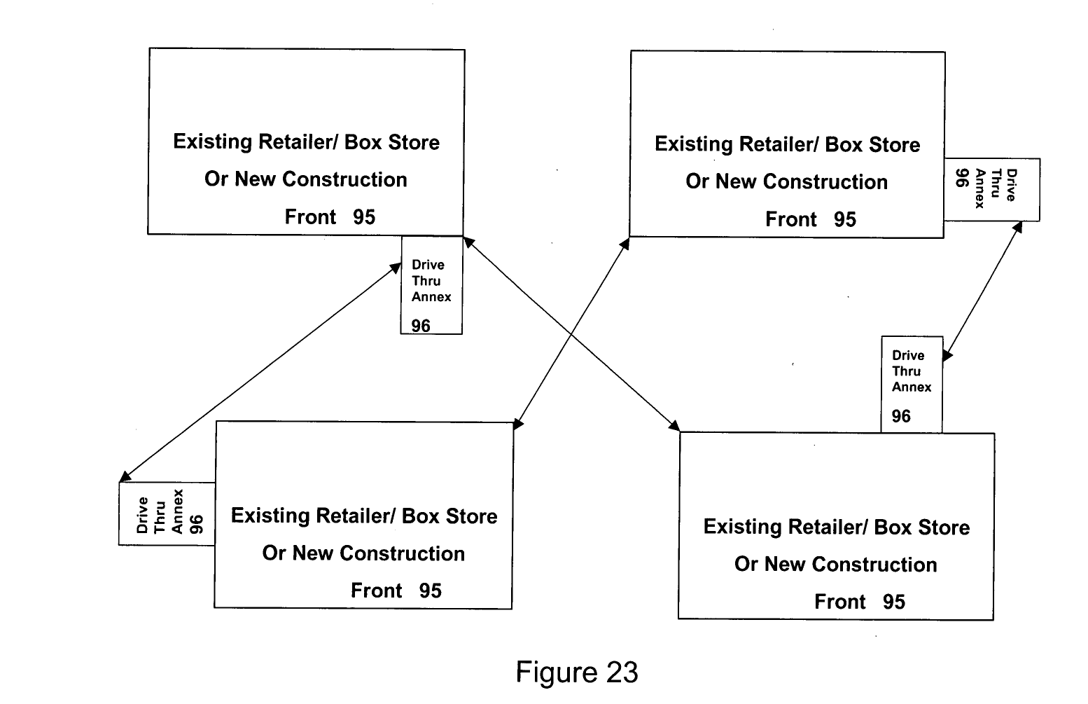

FIG. 23 graphically illustrates how several aspects of the facility of the present invention could be integrated within a traditional box store or retailer-warehouse 95 location. FIG. 23 illustrates, for example, a smaller facility or annex which has some or most of the capabilities described for the full facility 100 herein, but has at least a representative CORE system 27 in communication with like systems. The present facility 96 could be added to any location of the box store 95 which is optimized for product flow, traffic control and any structural or construction covenants restrictions. The facility 96 may be added to an existing location or be included as part of a new construction project. The annex 96 can use the same high speed delivery systems as the full facility 100 or like delivery systems. The CORE system may be revised to accommodate the needs of a box store or retailer-warehouse 95 location.

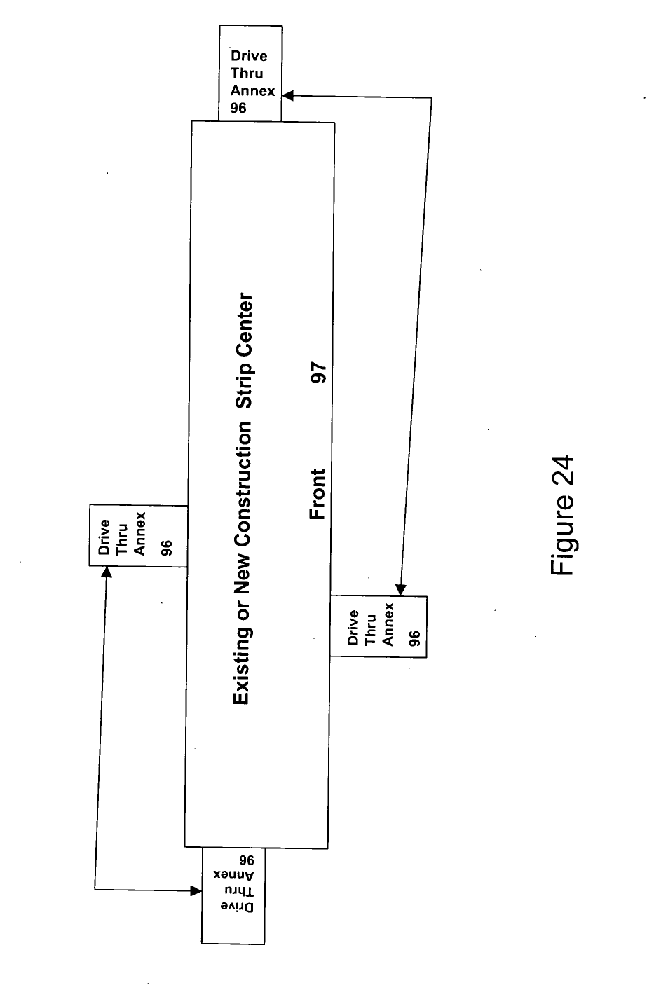

FIG. 24 graphically illustrates how several aspects of the facility of the present invention could be integrated within a traditional strip center or strip mall 97. Annex 96 could be added to an existing strip center or strip mall 97 or be included in a new construction. The present facility 96 could be added to any location or locations of the mall 97 which is optimized for product flow, traffic control and any structural or construction covenants restrictions. The facility 96 may be added to an existing location or be included as part of a new construction project. The annex 96 can use the same high speed delivery systems as the full facility 100 or like delivery systems. The CORE system may be revised to accommodate the needs of a strip center or strip mall 97 location.

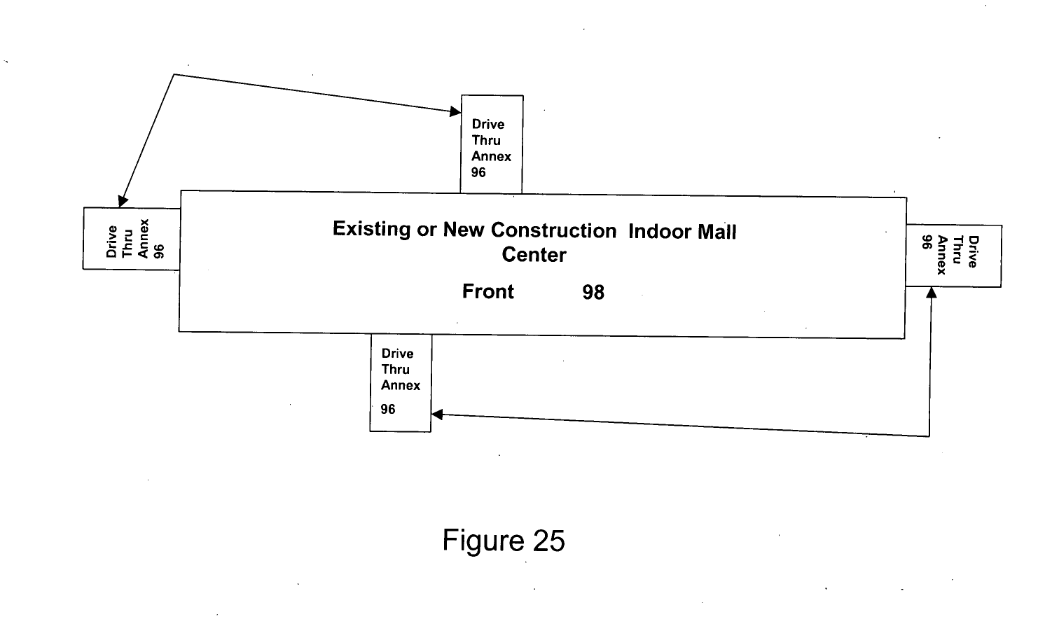

FIG. 25 graphically illustrates how several aspects of the facility of the present invention could be integrated within a traditional indoor mall 98. Annex 96 could be added to an existing strip center or strip mall 97 or be included in a new construction. The present facility 96 could be added to any location or locations of the mall 97 which is optimized for product flow, traffic control and any structural or construction covenants restrictions. The facility 96 may be added to an existing location or be included as part of a new construction project. The annex 96 can use the same high speed delivery systems as the full facility 100 or like delivery systems. The CORE system may be revised to accommodate the needs of an indoor mall 98 location.

Those of skill in the art will recognize that in any of the embodiments illustrated in FIGS. 23-25, the present invention may be modified to suit the needs of the structure and operations of the existing shops. For example, an exemplary OPDS 94 may be modified to accommodate delivery of specially shaped items offered by a vendor or tenant. It can also use manual delivery to the vehicle at the OPDS 94, or through a drive up window or delivery door. The OPDS 94 may also be scaled in size and number according to the market demands. As another example, multiple annexes 96 may be integrated into existing structures or new construction projects.

Those of skill in the art will now realize that additional ancillary service-oriented tenants may also be integrated into the present invention. For example, the present invention may facilitate various ancillary product and service facilities such as a car wash, an auto repair facility, a fuel dispenser, an auto lube and oil exchange facility and other convenience goods and services. The present invention may also encompass any type of consolidated repair service for any types of classified goods or serviceable items, whether or not communicating with the CORE system. These ancillary goods and service organization(s) may also be linked to the CORE system 27, thereby allowing for one-stop shopping convenience to a customer.

Additional features provided by the present invention may allow for full menu planning on line for family meals and social gatherings. In this example the present invention allows a consumer to pre-select the type of food and products to be served, whether raw products or ready to serve preparations, number of servings of each, and the CORE system will automatically order and process all of the items needed based on the information provided by the consumer. In this fashion, a consumer who is entertaining a small or large group of people can choose the cost, quality, and specific food or brand selection they desire for their meal or gathering and get everything in one order from the facility 100. If items are out of stock, then the order entry functionality will offer alternative items, or can back order the items from the proper tenant if circumstances allow.

The present invention contemplates housing tenants from various service industries, including but not limited to, banking, dry cleaning, photography development, locksmith, (music, games, books, video/DVD rental), repair services, parcel mailing and mail and parcel pick-up services. The present invention also contemplates housing tenants offering classified goods, such as for example grocery, office supply, hardware, electronics, florist, pharmaceuticals, music, games, books, video/DVD sales, CD (music) sales, lottery, book/magazines sales and electronic text library, prepared food, liquor sales, photo development, home and garden products, and other consumer goods.

Thus, for example, in one embodiment, a tenant involved in the banking industry could be linked to a specific OPS/ODS or OPDS strand within the facility 100. In most cases, the bank tenant will have an indoor facility to accommodate new accounts and will piggyback on the communication process of each ordering station and pickup station strands in the facility. Bank tellers will be able to visually/audibly interact with each facility customer for any type of bank service offered. The CORE system 27 will allow customers and banking personnel to directly speak through the audio/visual system. In this regard, the banking tenant may now be exposed to the customer base of the other products and services that patronizes the facility. The customer can now get most if not all of their banking services performed, and as well as their goods and services, all through a single faculty without driving to a dozen individual locations to accomplish the same tasks.

As another example, a tenant involved in the pharmaceutical industry may need its products to be handled specially due to the nature of goods provided and in order to meet governmental drug safety regulations as well as meet the requirements of privacy regulations and standards. Some customer drug prescriptions could, in some cases, be serviced and fulfilled personally through a walkup counter within the facility, whereas other order fulfillments could take place from a customer's vehicle. The pharmacy will have both indoor capabilities in the facility and full use of the delivery systems. In one embodiment, the present invention's IPOS system may be adapted to verify the prescription order right from the customer's vehicle by using a verification system such as a biometric verification system whether at the facility or remotely located. By using a biometric identification system, for example, the unique of properties of each customer can be initially stored be retained on file for subsequent confirmation to whom is picking up the prescription. Such biometric verification methodologies include, but are not limited to, fingerprints, eye patterns, visual (face) identification, non-invasive cell scans and others. Of course, such verifications should fully comply with applicable local, state and federal regulations. In turn, for example the pharmacy tenant could utilize and share the cost of the pneumatic tubes with the banking entity or other tenants within the facility to fulfill the customer's prescriptions. If the customer is picking up or ordering other items within the facility (such as groceries, dry cleaning, a movie rental, or prepared food), the prescription could be delivered through one of the ODS/OPDS delivery systems with the entire customer order. Those of skill in the art will recognize that a representative biometric verification system can communicate with the CORE system 27 through wirelan or wireless communication means.

Still another embodiment of the present invention resides in the facility's availability of multimedia rentals and purchases. In this regard, the term multimedia includes movie and game rental and purchase, book sales, music sales, magazines and any all forms of entertainment media and or multi-media. The present invention contemplates use of the facility 100 to allow a customer to access hardcopy (preprogrammed and pre-replicated) movie DVD's, computer and video games, books and other IP media or other valued media. As an example, a customer may first access the facility's media center either onsite or through the Internet to preview the various classifications of entertainment media, educational media, music, newspapers and magazines computer and video games, books and other intellectual property media or other valued media. If the hardcopy entertainment media, for example is inventoried and available at the facility 100, the facility process will accept instructions from the customer as to the date and time of pickup. If the preprogrammed and pre-replicated hardcopy entertainment media is not available in the targeted facility 100 inventory database as designated and verified by the DRWMS inventory management system, the DRWMS system could attempt to locate the requested item from other facility inventory database and if found, the CORE system 27 could designated a time when the requested item will be delivered and available for pickup at the auxiliary facility.

Another embodiment as described by this invention includes the on-site rental or purchase of preprogrammed and pre-replicated hardcopy entertainment media or other intellectual property forms. In this embodiment, for example, a customer could browse the selection of DVD movies, games or other storage mediums, formats and protocols from their vehicle in one of the OPS/ODS and or OPDS strands located within the facility. After the selection process takes place, the DRWMS will notify the multimedia tenant within the facility of the rental request. The customer will then Identify their membership and or other identifiers prior to the DVD being taken off the shelf either automatically or manually or semi-manually to the order assembly and consolidation area of the facility for bagging and delivery with other SIC/NICS classification goods or serviceable items if ordered. In some cases, if a customer desires only movie rental or equivalent small item, the item could be transported directly to the customer's OPS/ODS station. In like manner for customers that have a small item such as a DVD etc., the OPS/ODS stations are adapted to accept return of the items such as through a pneumatic tube.

Another embodiment contemplated by the present invention includes the access and retrieval of digital media from a customer's vehicle or proximity. Until the present invention, the access and retrieval of digital media in whatever form has never been designated to be accessed from a stand-alone facility. In this embodiment, the selected digital media is adapted to be stored, transmitted, received and otherwise communicated to a facility customer's storage device. A representative storage device may include, for example, a “cartridge”, a “memory module” or “storage medium,” or any device capable of storing, transmission and retrieval of digitized data. The transmission or communication of the digital media may be executed by either wirelan or wireless means. Each facility according to the present invention could optimally be equipped with high-speed broadband conductivity for high speed communication and transmission of data with a customer's storage device. In many cases, a customer may not have access to a broadband network. In these instances, the present invention contemplates a customer's pre-order of pre-programmed digital media on a rented digital storage device which can later be picked up by the customer at the facility from his or her vehicle.

As contemplated by the present invention, the facility 100 may be considered a repository or bank of digital media accessed by the customer in close proximity, directly from a customer's vehicle and preordered from a remote location by the customer, or browsed and retrieved when at the complex. In this regard, drive-thru customers may then browse and select a copy of various digital media access remotely and or at the facility. The phrase “digital media” as used herein, when used in connection with selected digital intellectual property (IP), refers to the content of the digitally stored IP file under consideration by a customer. The general applicability of various of the embodiments of the invention disclosed herein will be appreciated if it is understood, for example, that a “Digital IP” that is a television program includes “text” that is television programming. As another example, a “Digital IP” that is a musical recording includes audio, voice or music. Extending the analogy further, it is easily understood that one “reads” the “Digital IP” of the musical recording “IP” by playing the music via a system that converts the digitally encoded audio into sound.

The phrase “user's computer” or “user's device,” as used herein, refers to any electronic device performing some or all of the functions traditionally associated with a typical desktop computer, including, but not limited to, a traditional desktop computer, a laptop computer, PDA device, wireless connecting device, Internet connecting device, digital telephone, video gaming device, or another electronic device capable of being electronically connected with a network. The terms “user's computer” and “user's device” do not necessarily refer to different types of units.

Further, as used herein, the term “nonvolatile memory” refers generally to a type of memory that does not depend upon power being continuously applied to retain information and used to store and protect against end user piracy. Various hardware device and software companies, content owners and other enablers would integrate their products and services with the facility's CORE system 27. This integration may find some importance, as the Digital Media consist of only one classification (including subgroups) of SIC/NICS classifications of thousands the classified goods and services offered at the facility. The integration process of these previously identified technology and content companies could include but is not limited to the ergonomics and Digital Rights Management of the media, the time period used and eraseability, the return policy, the distribution network used to transfer and or accessed remotely to digital media customers of the facility, the customer interface and hardware device, the multimedia player and retrieval software the media consideration to the kiosk (interface) device located at the OPS, ODS and OPDS strands, data access rate, remote location or at site location access, data transfer rate, interface devices, and to whether the application requirements including but not limited to programmable, and/or reprogrammable of the customer's hardware device.

Therefore, in one embodiment, a customer or user may select portions or entire contents of one or types of digital information such as a specific digital song title, digital book chapter, promotional digital excerpt or other parts or subgroup of a total digital IP heading. Customers may also use any storage device that will be compatible or will be made compatible with the kiosks within the facility or kiosk. The storage media devices should preferably be “DRM Configured” and contain the instructions or data recorded thereon to control access by an access device to data recorded thereon. Also included are protected segregated portions of a data storage portion of a hard disk, and any other device for the storage of data electronically in digital form and providing controlled access thereto. In one embodiment, a cartridge includes a unique identification number and a predetermined amount of memory for storing the selected information.

In another embodiment, a cartridge also includes specialized controlling or digital management software stored in nonvolatile memory, either on a separate memory chip of the cartridge, or in a segregated protected space within a general memory storage space of the cartridge. The DRM controller may be electronically linked to the cartridge on which it is stored, and may control and regulate reading and use of encrypted and tagged data information files stored within the general memory of the cartridge. As long as any portion of encrypted data stored on the cartridge is being accessed, DRM controller should preferably remain functioning and-regulate and control functions that the user is permitted to perform with regard to encrypted data in question. For example, in most cases, when an encrypted data file is accessed for reading, the DRM controller operates to restrict the ability of the user to copy the data in a decrypted form or to print data onto hard copy. The DRM controller also restricts the user from copying any portion of the decrypted data to any data file other than a temporary file in RAM that is automatically erased when DRM Controller storing the operating as an encrypted file that is only readable using DRM Controller operating on authorized equipment. When the user ceases accessing encrypted data files, and DRM controller ceases operation, just prior to closing down, DRM controller totally erases all record of any decrypted data and all temporary files in which such data may have been stored. Once DRM controller has ceased operation, the user is no longer able to access any of the temporary files generated during previous operation, as all record of such files ever existing and the content contained therein will have been permanently excised from the user's system.

Thus, in connection with related application software stored within the user's device, DRM controller utilizes one or more of the dynamic encryption and decryption features, a unique serial or registration number, and various data registration headers to regulate and govern any use the user makes of encrypted files and the data stored within. Without DRM controller operating, a user is unable to gain access to the encrypted data. In one embodiment of the invention, DRM controller contains monitoring features that prevent operation of DRM controller should any attempt be made to alter its operation. In one embodiment, when DRM controller becomes inoperable for any reason, the user of the device has to bring the affected cartridge to an authorized agent for repair or replacement.

In another exemplary embodiment of the exemplary PRM controller software, the DRM controller finds the information necessary to decrypt an encrypted text. While the user device in which the DRM controller resides is operating, the DRM controller restricts what the user device is capable of doing. For example, it may restricts the user device so that it cannot write information to an external storage device while an internal storage device having an encrypted text is being used. And, when a cartridge is disengaged from the user device by removal, the DRM controller may shut downs the user device, for example, either by shutting down its program or by operating an electronic switch to remove power from the user device. DRM controller may also be adapted to remove all temporary files related to the program from the user device. In addition, DRM controller may read a secure real-time clock in the user device to determine whether the user device is presently authorized to access data on a cartridge. DRM controller may also register or record when tampering occurs, such as a change in the real-time clock data caused by an obvious backdating attempt.

The term “Digital Media Bank,” as used herein, refers generally to an interface between a network and a user. Such interface may be physically located in proximity to a central digital media information storage facility, at a location remote from a central information storage facility (for example, in a physical housing such as a kiosk located at one of the many OPS/ODS and/or OPDS stations), or in proximity to and directly connected to a user's computer or hand-held device or as one example, an automobile stereo system. Those of skill in the art will also recognize that appropriate equipped kiosks may be situated as stand-alone devices in communication with a facility, so that an appropriate kiosk does not have to be located in a facility, and rather, may be remotely located (such as within an indoor mall) for communication with customers. The Digital Media Bank may be wholly or partially a virtual device generated from an interaction a software program stored on a user's computer and software located at another Digital Media Bank or a central information storage facility either at the facility 100 or at a remote location and linked to the facility.

In embodiments involving a virtual device, some of the hardware necessary for operation of a Digital Media Bank may be located proximate to or within a user's computer, or proximate to or within the Digital Media Bank or the central information storage facility, depending upon a location at which user contact is made. For example, in one embodiment, a “Digital Media Bank” comprises memory storage, a processing unit, a keyboard, slots for credit cards, slots for storage media on which downloaded digital data such as electronic versions of text are stored and a printer (for bills and receipts). A virtual “Digital Media Bank” may also comprise, for example, only a memory and a processor (located at, e.g., a facility establishment, a data storage center within the facility, or at a security encryption compression module. The selected information is then combined and downloaded to the user's data storage device. Customers may also use keyboards, voice activation, wireless laser mouse or any other device to access the digital music, digital books, digital games, digital movies and other digital media information from their automobile when at the complex. The facility's customer could, from his or her vehicle, add the payment for the rental or purchase of the digit media to their overall bill when at the facility using the same identification process disclosed previously. The facility customer could also access the Digital Media Bank's library of digital music, digital books, digital computer and video games, digital movies and other digital media information such as voice, video, graphic images, natural language and other text, audio, computer software material, and any other type and/or any portion of combination of the above, and/or other types of intellectual property capable of being accessed, updated (inventory, prices and promotions), browsed and converted to and stored in digital form through his or her handheld device. The handheld device could also be instantly updated with prices for every SIC/NAICS good and service within the complex. Electronic promotion discounts, specials, discounts and coupons could also be accessed, updated (price discounts and other promotions) and browsed and converted to and stored in digital form.

In another embodiment, each Digital Media Bank may comprise at least one processor, at least one monitor, at least one network connection, and at least one input means configured for insertion or communication of a portable memory storage medium and/or a connection to a user device, for example, a portable digital assistant (PDA). Other information is transferred via a network to a Digital Media Bank for supplemental, secondary, and less demanded purposes. At least one processing unit within the Digital Media Bank and coupled to the Digital Media Bank local memory and storage controls downloading and dynamic encryption of information.

The present invention also contemplates customers exchanging memory storage devices when at the facility with another storage device(s) containing different digital media desired to purchase or rent. Additionally, digital media could be transferred directly to the storage media or exchanged from an input means (such as, for example, slot or slots) located within or adjacent to the kiosk when a customer is at the OPS, ODS or OPDS, or exchanged or otherwise transferred by wireless communication.

In yet another embodiment, the customer's memory storage device may utilize a high-speed wireless retrieval process used to store secure digital media in either encrypted or non-encrypted formats. Representative customer storage devices could include any and all forms of storage media, set top boxes, PC storage media, car and home stereos or any other hardware device capable of receiving, reconstituting, transmitting and playing digital media.

In any of the foregoing embodiments, the description of digital data is not dependent upon the format of the stored digitized material, and is equally applicable whether the digitized material is stored using any type of software system, hardware device or any other format.

Another embodiment of the present invention enables a user to obtain updates to any data information file he or she has acquired, by communicating with an update or a central data storage facility, or by using the Internet to access an Digital Media Bank or a central data storage facility through an appropriate link via a web site, or the use of a wireless network (e.g., digital satellite, cellular, wireless mobile, microwave, infrared, etc.) to gain access to an Digital Media Bank or the central data storage facility over any network or connection. In one embodiment, a Secure Universal Resource Locator (SURL) is used, including both a secure phone number as well as an Internet-based URL. The same restrictions apply to obtaining an update as to acquire the data information file being updated.

In yet another embodiment, digital music excerpts and promotional samples could be accessed through a handheld device and played for example through the car stereo via a multi-channel radio frequency access system. In this regard, customers could tune in the designated frequency channel when at the facility 100 and play the music sample prior to purchase. In yet another embodiment, print-on-demand for hardcopy books could be implemented using the digital database and retrieval system within the facility and printed for the customer after purchase.

In another aspect of the present invention, the facility process may also allow a customer to order classified goods or serviceable items on-site or offsite. The offsite order facilitation may include an e-commerce menu and browser that would illustrate the various classified goods and services offered, either by two-dimensional view or by three-dimensional view.

In yet another embodiment, the present invention contemplates offering customers lottery tickets, event tickets or like items. In this regard, the facility process may allow a customer to pre-order a lottery ticket either by random number choice, or by selectively choosing specific lottery numbers. When the pre-order customer arrives at the facility's OPS/ODS or OPDS station, he could then verify his identification based on any of the previous disclosures. Upon identify confirmation, the faculty process will process the lottery ticket and deliver it to the customer either with his or her additional SIC/NAICS order. A lottery ticket could also, in some cases, be distributed through the pneumatic tube or be delivered apart of the full order through one of the OPS/ODS and or OPDS strands if size dictates (such as through, for example a customer service area). This segment includes all forms of hardcopy ticket sales for entertainment events, sporting events, airline, bus, ship, car, rail tickets, lottery and gaming and other tickets.

In another embodiment based on delivery of tickets, the present invention also contemplates the potential transformation or introduction of digital media and digital intellectual property for access and retrieval thru the facility. In this regard, the facility may utilize several embodiments described by the Multimedia Entertainment Rental and Purchase SIC/NAICS segment if lottery tickets, including Powerball and various state lotteries, are sold electronically. If lottery tickets are sold electronically through the customer's handheld device, a communication network, encryption, storage, or wireless radio frequencies capabilities must be put in place in order to accomplish such a task. The customer in this case could enter the number(s) he or she wishes and choose the state lottery, Powerball or other lotteries around the World. The governmental organization will then post the numbers and confirm the customer's purchase. The customer would receive electronic confirmation on the lottery tickets and on the date the lottery is held, the customer will be informed by the previously described alert system, or through various means including radio frequency, where he or she won or lost.

The present invention is also readily adaptable to allow a consumer to shop for classified goods and serviceable items through the use of three-dimensional imagine. For example, the browser and product description and display upon an order entry means could contain holographic images and descriptions. The consumer may then wear virtual shopping goggles or other means of visualizing which are in communication with the CORE system 27 when viewing products and services. Since seeing three dimensional products such as produce or picking up cans to read the label are not possible from an individual's automobile, a special adaptation using three dimensional virtual shopping may help make the shopping experience feel more conventional. This aspect may be used for both on-site and offsite ordering processes. For example, onsite and offsite customers could use handheld and tablet devices, virtual shopping goggles, and home PC's to experience a “real shopping experience” feeling through these new technologies. The current invention could also allow the customer to visually zero-in on a product when making his or her purchase decision. For example, a customer could view a display of bananas and focus in on the bunch he or she wishes to purchase from the visual display. A holographic or virtual shopping experience could not only view a can of green beans but virtually turn or rotate the can around in a three dimensional fashion in order to read the label. The customer could compare price per ounce on the virtual label in order to compare it to other products.

Additionally, the present invention also contemplates the use of virtual scent. An olfactory unit containing a combination of scents could be recreated a simulated from their virtual shopping network. Olfactory scents could correlate with the category of products or services selected by the customer. If bakery items are selected for example, a bakery smell could be electronically released from the customers sensory device. Virtual shopping software and hardware devices could also simulate the tactile feel and texture of the product. For example, if an artichoke is pickup through the virtually shopping device by the consumer, the texture and feel of the artichoke could be felt through the virtual shopping gloves if the customer chooses this option. The weight could also be simulated electronically. The computer could be programmed to electronically simulate the weigh of a 16-ounce can.

Several aspects of the present invention may also be used for setting up a membership facility which provides frequent customers the opportunity to pay an annual fee to be members. Such a membership process allows each participant to receive early sales notification of products and services they regularly use, notice of price changes, or to obtain notices of coupons or other promotions for classified goods and services. Thus, according to one aspect of the invention, the membership facility process will allow a member to be notified of product changes before it actually happens, product availability, order availability and other similar information sent out regularly via e-mail to all members.

The present invention may also house a prepared food entity through ownership or contract adapted to offer a pre-selected menu items from pre-defined restaurants, thereby giving a consumer a wide variety of food types in a high quality and fast service format, all within the same location. For example, the present invention may consolidate several pre-selected menu items from established restaurants and reproduce such items in one restaurant kitchen, all inside one establishment. The types of cuisine, restaurant mix and specialty items will vary from each facility in order to meet the needs of the community. The consolidation of various restaurant specialties in one sit-down service facility will provide greater expansion opportunities to the “Parent” or base restaurant, while greatly mitigating the risks of expansion. The “Parent” restaurants can vary from a variety of establishments from North American and or Europe, South America, Asia, Middle East, Scandinavia, Russian or any other locations, in the World. The featured “Parent” restaurants may be consolidated and featured within one menu, one operational facility, and under a singular management group. “Parent” restaurants could include as an example; a well known Chinese restaurant from China Town in San Francisco, a NY City Deli, a Boston seafood restaurant, a Kansas City barbeque restaurant, a Oklahoma Steak Restaurant, a Cajun Restaurant from New Orleans or any combination of well known established restaurants. The restaurant mix could vary in accordance to the demographics needs of a particular community. In addition the number of “Parent” restaurants within the facility could vary or the establishment could change to different “Parent” restaurants if particular “Parent” restaurants and not selling the minimum requirements of their cuisine. The “Parent” restaurant could feature special and also have the flexibility to substitute one specialty menu item with another to meet the taste of the new local community and demographic mix. The invention for the first time provides the “Parent” restaurant the flexibility needed for strategic concentric growth without the inherent risk factors as described above.

It is also possible that an existing restaurant or chain might contract with the facility 100 to operate the food service portion of the facility. It is further possible for a single entity that might have expertise and reputation in more than one cuisine type to participate as the featured restaurant with some or all of those cuisine types. The foods prepared in the food service portion of the facility 100 may be purchased both by walking into the facility for either sit down or take out dining, as well as through the drive-thru delivery system to any of the ODS stations, or to specified food only delivery stations which could include but is not limited to mechanical delivery as used in the rest of the facility, drive-up window as is currently used in the industry or customer service area using doors traditional or sliding. In this case, warmer, cooler or freezer holder carousels may be used to allow the food preparation restaurant facility to prepare and hold finished dishes for a limited time for Drive-thru pre-order customers or for consolidation purposes while other ordered items are being assembled. Additionally each ODS/OPDS strand could service all prepared food menu items delivered to each facility customer. Each ODS/OPDS delivery shuttle may also be equipped with drink holds, or totes with drink holder as well as temperature control devices that will maintain the quality of the prepared menu items.

The novelty of the present invention should be clearly recognized by those of skill in the art in light of current retail and commercial practices. For example, in a standard drive-thru configuration, there is a single tenant product or service SIC/NAICS classifications being handled through that drive-thru facility. Examples would be fast food, banking, pharmacy, dry cleaning and others. The present invention provides a single stop approach in combination with electronic, mechanical, software and other technologies to deliver a wide variety of classified products and services directly to the consumers vehicle. In similar fashion, when a consumer currently has home delivery across product or service categories, they typically deal with multiple vendors, multiple delivery personnel and delivery times. With the advances disclosed in the present invention, when a home delivery service is ordered through the facility 100, that delivery will include multiple SIC /NAICS coded products and services that the consumer ordered, in one delivery.

In another aspect of the present invention, a distribution technology may be employed to govern the restocking of another particular facility 100 based on a method of process of automated synchronistic procurement. In this configuration, an inventory storage sequence of a particular facility 100 may be electronically charted by a representative distribution CORE system. Its e-inventory storage sequence is electronically filed at the time of inventory loading. The distribution warehouse inventory loading process through this invention contemplates electronically mapping the current inventory location, number of storage bins or pods and their corresponding products, the number of product units inventoried and the number of units required. Electronic inventory sequencing by a distribution CORE system will create an inventory-packing model from the distribution warehouse that reads the inventory control sequence, the sites current inventory and the needed replenished supplies. The dynamic warehouse management system's retrieval software network of the distribution CORE system will read the facility's inventory e-blueprint and warehouse management. The inventory e-blueprint inventory system will then be reproduced electronically and automatically conveyed, carted and packed. The quantity of replenished inventory could be in individual units or distributed by caseload into a truck in reverse order to the order automatically received at the facility. When at the facility, the e-blueprint is programmed for inventory deliverables. The individual products and or caseloads will be automatically conveyed to the location specified by the programmed e-blueprint.

As will be appreciated by one of ordinary skill in the art, the present invention may be embodied as a method, a process, a data processing system, a firmware system, a hardware system, and/or a computer program product or a combination thereof. Accordingly, the present invention may take the form of an entirely software embodiment, an entirely hardware embodiment, or an embodiment combining aspects of both software and hardware. Additionally, in the foregoing specification, the invention has been described with reference to specific embodiments. However, it will be appreciated that various modifications and changes can be made without departing from the scope of the present invention as set forth in the claims below. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented in the claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or“critical”.

Other variations and modifications of the present invention will be apparent to those of ordinary skill in the art, and it is the intent of the appended claims that such variations and modifications be covered. The particular values and configurations discussed above can be varied, are cited to illustrate representative embodiments of the present invention and are not intended to limit the scope of the invention. It is contemplated that the use of the present invention can involve components having different characteristics as long as the principle is followed.

1. A process for controlling a vehicle drive-thru or drive-up facility, the process comprising:
providing a structural facility adapted to receive, store and deliver commercial and retail classified goods and serviceable items, the structural facility having a centralized order processing portion and a plurality of vehicle drive-thru pick up areas attached to the centralized processing portion adapted to receive a customer's vehicle;
introducing at least one core computer system communicatively compatible with a customer and with other computers communicating with the core computer system, the core computer system adapted to control, access and deliver the classified goods and serviceable items from within and outside of the facility to a customer's location, adapted to control and access the centralized order processing portion and adapted to control the plurality of drive-thru pick up areas for potential delivery of classified goods and serviceable items to a customer and for potential acceptance of items from a customer, the core computer system further adapted to optimize traffic flow through the drive-thru pick up area.

2. The process according to claim 1, wherein the vehicle drive-thru pick up area comprises a plurality of staging lanes to accommodate a plurality of customer vehicles, each staging lane being in communication with the core computer system to control traffic.

3. The process according to claim 2, wherein the vehicle drive-thru pick up area further comprises at least one order placement and delivery station therein, the order placement and delivery station adapted to receive, process and deliver at least one order from a customer.

4. The process according to claim 3, the order placement and delivery station further adapted to receive service items from a customer.

5. The process according to claim 3, each order placement and delivery station adapted to receive communications from the customer by at least one electronic means, the electronic means in communication with the core computer system.

6. The process according to claim 5, the electronic means adapted to communicate with a customer and with other computer systems by voice transmission, by voice synthesizer transmission, by audio transmission, by audio-visual transmission, by radio frequency transmission, by electronic signal transmission, by a touch screen; including by any type of wireless protocol comprising cellular, microwave, 802.11x, Bluetooth, satellite; and including by wirelan protocol comprising a telephone, a handheld devices, an onsite or offsite communication device, a point device, a touch device, a personal computer or any combination thereof.

7. The process according to claim 6, the electronic means further comprising a pre-ordering communication means, the pre-ordering communication means adapted to facilitate communications between the customer and any tenant, and between the customer and any computer network in communication with the core computer system, the pre-ordering communication means further adapted to provide pre-sale information to the customer, pricing, including specials, discounts, close-outs and related pre-sales information, corresponding to the classified goods and serviceable items.

8. The process according to claim 7, the pre-ordering communication means is further adapted to verify customer identification, verify order information and perform payment processing.

9. The process according to claim 8, the pre-ordering communication means further adapted to facilitate communications between at least one remote electronic device and the core computer system to allow a customer to select the desired classified goods or services, order the selected classified goods or services, and receive confirmation corresponding to the order pick up availability.

10. The process according to claim 9, the pre-ordering communication means comprising a remotely located computer device adapted to provide communications to a remotely located customer regarding events, promotions, electronic coupons, price changes, specials, new products and other information, the computer device further adapted to store and display the classified goods and service offerings available for customer order.

11. The process according to claim 9, the pre-ordering communication means comprising a remotely located computer device adapted to provide communications to a remotely located customer, the computer device adapted to receive and store customer information, customer preferred product information, and past customer order information, and is further adapted to track discarded goods, track inventory for replenishment, generate future order information, and upon command by the customer, replenish goods by communicating at least one order to the core computer system for subsequent delivery to the customer.

12. The process according to claim 11 wherein the core computer system is adapted to deliver ordered goods or services to a customer's location.

13. The process according to claim 5 further comprising a verification system in communication with the core computer system, the verification system adapted to authenticate identification of the customer who is purchasing the ordered good or service, verify the customer's ability to purchase the ordered good or service, and if authentication and identification is confirmed, communicate to the core computer system to deliver the ordered good or service to the customer.

14. The process according to claim 13, the verification system comprising a biometric verification system, the biometric verification system selected from the group of fingerprint verification, eye pattern verification, visual (face) identification verification, license scanning verification, voice verification, vehicle identification verification and, non-invasive cell scan verification.

15. The process according to claim 3, the core computer system is adapted to communicate with at least one e-commerce network site to receive, send, track, process and verify orders made by an authenticated customer on the e-commerce network site, and is further adapted to notify the customer of the order availability and to deliver ordered goods to a customer's location.

16. The process according to claim 3, wherein the facility further comprises a pre-defined area for receiving customer exchanged goods, receiving damaged goods, receiving mis-processed goods, processing special handle goods and providing refunds if necessary, the pre-defined area being in communication with the core computer system through a materials handling system.

17. The process according to claim 3, wherein the facility further comprises a pre-defined area for customer service, the pre-defined area being in communication with the core computer system through a materials handling system.

18. The process according to claim 3, wherein the facility further comprises a pre-defined area for customer assistance, the pre-defined area being in communication with the core computer system through a materials handling system.

19. The process according to claim 3 wherein the faculty further comprises a pre-defined food pick up area within the drive-thru pick up area, the prepared food pick up area adapted to deliver food pre-ordered by a customer.

20. The process according to claim 3, wherein the facility further comprises at least one pre-defined area for receiving, storing and transporting goods and services which require predefined environmental controls.

21. The process according to claim 20, wherein environmental controls are selected from the group of humidity controls, product rotation controls, expiration controls, heat controls, refrigeration controls, ambient temperature controls, dry goods handling controls, special handling controls, packaging controls, secure access controls, consolidation and bagging controls and air circulation controls.

22. The process according to claim 3, wherein the core computer system is adapted to monitor or otherwise sense emissions from a vehicle within or adjacent to the facility, and control one or more exhaust control systems in the facility to vent away the emissions from the facility.

23. The process according to claim 3, wherein the structural facility is adapted to annex to, or otherwise structurally couple to, an existing structure specializing in providing wholesale goods or services.

24. The process according to claim 3, wherein the structural facility is adapted to annex to, or otherwise structurally couple to, an existing strip center.

25. The process according to claim 3, wherein the structural facility is adapted to annex to, or otherwise structurally couple to, an existing box store structure.

26. The process according to claim 3, wherein the structural facility is adapted to annex to, or otherwise structurally couple to, an existing outdoor mall structure.

27. The process according to claim 3, wherein the structural facility is adapted to annex to, or otherwise structurally couple to, an existing indoor mall structure.

28. The process according to claim 2, wherein the vehicle drive-thru pick up area further comprises at least one order placement station and at least one delivery station therein, the order placement station and the order delivery station adapted to receive, process and deliver at least one order from a customer.

29. The process according to claim 28, the order placement and delivery station further adapted to receive service items from a customer.

30. The process according to claim 28, each order placement and delivery station adapted to receive communications from the customer by at least one electronic means, the electronic means in communication with the core computer system.

31. The process according to claim 30, the electronic means adapted to communicate with a customer and with other computer systems by voice transmission, by voice synthesizer transmission, by audio transmission, by audio-visual transmission, by radio frequency transmission, by electronic signal transmission, by a touch screen; including by any type of wireless protocol comprising cellular, microwave, 802.11x, Bluetooth, satellite; and including by wirelan protocol comprising a telephone, a handheld devices, an onsite or offsite communication device, a point device, a touch device, a personal computer or any combination thereof.

32. The process according to claim 31, the electronic means further comprising a pre-ordering communication means, the pre-ordering communication means adapted to facilitate communications between the customer and any tenant, and between the customer and any computer network in communication with the core computer system, the pre-ordering communication means further adapted to provide pre-sale information to the customer, pricing, including specials, discounts, close-outs and related pre-sales information, corresponding to the classified goods and serviceable items.

33. The process according to claim 32, the pre-ordering communication means is further adapted to verify customer identification, verify order information and perform payment processing.

34. The process according to claim 33, the pre-ordering communication means further adapted to facilitate communications between at least one remote electronic device and the core computer system to allow a customer to select the desired classified goods or services, order the selected classified goods or services, and receive confirmation corresponding to the order pick up availability.

35. The process according to claim 34, the pre-ordering communication means comprising a remotely located computer device adapted to provide communications to a remotely located customer regarding events, promotions, electronic coupons, price changes, specials, new products and other information, the computer device further adapted to store and display the classified goods and service offerings available for customer order.

36. The process according to claim 34, the pre-ordering communication means comprising a remotely located computer device adapted to provide communications to a remotely located customer, the computer device adapted to receive and store customer information, customer preferred product information, and past customer order information, and is further adapted to track discarded goods, track inventory for replenishment, generate future order information, and upon command by the customer, replenish goods by communicating at least one order to the core computer system for subsequent delivery to the customer.

37. The process according to claim 36 wherein the core computer system is adapted to deliver ordered goods or services to a customer's location.

38. The process according to claim 30 further comprising a verification system in communication with the core computer system, the verification system adapted to authenticate identification of the customer who is purchasing the ordered good or service, verify the customer's ability to purchase the ordered good or service, and if authentication and identification is confirmed, communicate to the core computer system to deliver the ordered good or service to the customer.

39. The process according to claim 38, the verification system comprising a biometric verification system, the biometric verification system selected from the group of fingerprint verification, eye pattern verification, visual (face) identification verification, license scanning verification, voice verification, vehicle identification verification and, non-invasive cell scan verification.

40. The process according to claim 28, the core computer system is adapted to communicate with at least one e-commerce network site to receive, send, track, process and verify orders made by an authenticated customer on the e-commerce network site, and is further adapted to notify the customer of the order availability and to deliver ordered goods to a customer's location.

41. The process according to claim 28, wherein the facility further comprises a pre-defined area for receiving customer exchanged goods, receiving damaged goods, receiving mis-processed goods, processing special handle goods and providing refunds if necessary, the pre-defined area being in communication with the core computer system through a materials handling system.

42. The process according to claim 28, wherein the facility further comprises a pre-defined area for customer service, the pre-defined area being in communication with the core computer system through a materials handling system.

43. The process according to claim 28, wherein the facility further comprises a pre-defined area for customer assistance, the pre-defined area being in communication with the core computer system through a materials handling system.

44. The process according to claim 28 wherein the faculty further comprises a pre-defined food pick up area within the drive-thru pick up area, the prepared food pick up area adapted to deliver food pre-ordered by a customer.

45. The process according to claim 28, wherein the facility further comprises at least one pre-defined area for receiving, storing and transporting goods and services which require predefined environmental controls.

46. The process according to claim 45, wherein environmental controls are selected from the group of humidity controls, product rotation controls, expiration controls, heat controls, refrigeration controls, ambient temperature controls, dry goods handling controls, special handling controls, packaging controls, secure access controls, consolidation and bagging controls and air circulation controls.

47. The process according to claim 28, wherein the core computer system is adapted to monitor or otherwise sense emissions from a vehicle within or adjacent to the facility, and control one or more exhaust control systems in the facility to vent away the emissions from the facility.

48. The process according to claim 28, wherein the structural facility is adapted to annex to, or otherwise structurally couple to, an existing structure specializing in providing wholesale goods or services.

49. The process according to claim 28, wherein the structural facility is adapted to annex to, or otherwise structurally couple to, an existing strip center.

50. The process according to claim 28, wherein the structural facility is adapted to annex to, or otherwise structurally couple to, an existing box store structure.

51. The process according to claim 28, wherein the structural facility is adapted to annex to, or otherwise structurally couple to, an existing outdoor mall structure.

52. The process according to claim 28, wherein the structural facility is adapted to annex to, or otherwise structurally couple to, an existing indoor mall structure.

53. The process according to claim 1, wherein the step of introducing a core computer system further comprises the steps of allowing the core computer system to:
direct a customer to an ordering placement station;
receive communications from, and transmit communications to, the customer through an electronic means corresponding to an ordered classified good or serviceable item, the electronic means being in communication with the core computer system;
obtain remuneration from the customer;
control and operate a materials handling system to obtain the ordered good or serviceable item from within a pre-defined portion of the facility, and transport the ordered good or serviceable item to an order assembly and consolidation area within the facility;
direct the customer to an order delivery station;
if a customer is not waiting for delivery, transport the ordered goods or serviceable item to a staging area for later delivery; and
if a customer is waiting for delivery, transport the ordered goods or serviceable item to the customer to a pre-selected delivery station.

54. The process according to claim 53, the electronic means adapted to communicate with a customer voice transmission, by voice synthesizer transmission, by audio transmission, by audio-visual transmission, by radio frequency transmission, by electronic signal transmission, by a touch screen; including by any type of wireless protocol comprising cellular, microwave, 802.11x, Bluetooth, satellite; and including by wirelan protocol comprising a telephone, a handheld devices, an onsite or offsite communication device, a point device, a touch device, a personal computer or any combination thereof.

55. The process according to claim 54 further comprising the steps of allowing the core computer system to:
verify that the ordered good or serviceable item is available; and
transmit order information to at least one tenant within the facility.

56. A method for managing a facility offering classified goods and serviceable items by at least one core computer system, the facility containing a plurality of vehicle drive-thru areas, the steps comprising the core computer:
directing a customer vehicle to an order station through a traffic control system in communication with the core computer;
receiving the customer's order information through an electronic means;
communicating the customer's historical order data through the electronic means;
receiving payment from the customer corresponding to the order;
verifying and processing the order; and
directing the customer to a delivery station for order delivery.

57. The method of claim 56 wherein the step of processing the order further comprises the steps of:
Notifying the customer of the inventory status;
Controlling a materials handling system to obtain the ordered good or serviceable item from within a pre-defined portion of the facility, and transport the ordered good or serviceable item to an order assembly and consolidation area within the facility;
Communicating any order information to a corresponding tenant's computer processing system;
Transmitting corresponding financial information to the corresponding tenant's computer processing system;
confirming that the order corresponds to the customer who placed the order;
if a customer is not waiting for delivery, controlling the materials handling system transport the ordered goods or serviceable item to a staging area for later delivery to the customer to a pre-selected delivery station; and
if a customer is waiting for delivery, controlling the materials handling system to transport the ordered goods or serviceable item to the customer to a pre-selected delivery station.

58. The method of claim 56 wherein the electronic means communicates with the customer by voice transmission, by voice synthesizer transmission, by audio transmission, by audio-visual transmission, by radio frequency transmission, by electronic signal transmission, by a touch screen; including by any type of wireless protocol comprising cellular, microwave, 802.11x, Bluetooth, satellite; and including by wirelan protocol comprising a telephone, a handheld devices, an onsite or offsite communication device, a point device, a touch device, or a computer;

59. The method of claim 57 wherein the pre-defined portion of the facility comprises at least an area storing high customer demand classified goods or serviceable items, an area storing frequently purchased classified goods or serviceable items and an area storing remaining classified goods or serviceable items, these areas in communication with the core computer system through the materials handling system.

60. The process according to claim 56, the electronic means further comprising a pre-ordering communication means, the pre-ordering communication means adapted to facilitate communications between the customer and any tenant, and between the customer and any computer network in communication with the core computer system, the pre-ordering communication means further adapted to provide pre-sale information to the customer, pricing, including specials, discounts, close-outs and related pre-sales information, corresponding to the classified goods and serviceable items.

61. The process according to claim 60, the pre-ordering communication means is further adapted to verify customer identification, verify order information and perform payment processing.

62. The process according to claim 60, the pre-ordering communication means further adapted to facilitate communications between at least one remote electronic device and the core computer system to allow a customer to select the desired classified goods or services, order the selected classified goods or services, and receive confirmation corresponding to the order pick up availability.

63. The process according to claim 60, the pre-ordering communication means comprising a remotely located computer device adapted to provide communications to a remotely located customer regarding events, promotions, electronic coupons, price changes, specials, new products and other information, the computer device further adapted to store and display the classified goods and service offerings available for customer order.

64. The process according to claim 60, the pre-ordering communication means comprising a remotely located computer device adapted to provide communications to a remotely located customer, the computer device adapted to receive and store customer information, customer preferred product information, and past customer order information, and is further adapted to track discarded goods, track inventory for replenishment, generate future order information, and upon command by the customer, replenish goods by communicating at least one order to the core computer system for subsequent delivery to the customer.

65. The process according to claim 62 wherein the core computer system is adapted to deliver ordered goods or services to a customer's location.

66. The process according to claim 57 further comprising a verification system in communication with the core computer system, the verification system adapted to authenticate identification of the customer who is purchasing the ordered good or service, verify the customer's ability to purchase the ordered good or service, and if authentication and identification is confirmed, communicate to the core computer system to deliver the ordered good or service to the customer.

67. The process according to claim 66, the verification system comprising a biometric verification system, the biometric verification system selected from the group of fingerprint verification, eye pattern verification, visual (face) identification verification, license scanning verification, voice verification, vehicle identification verification and, non-invasive cell scan verification.

68. The process according to claim 57, the core computer system is adapted to communicate with at least one e-commerce network site to receive, send, track, process and verify orders made by an authenticated customer on the e-commerce network site, and is further adapted to notify the customer of the order availability and to deliver ordered goods to a customer's location.

69. The process according to claim 57, wherein the facility further comprises a pre-defined area for receiving customer exchanged goods, receiving damaged goods, receiving mis-processed goods, processing special handle goods and providing refunds if necessary, the pre-defined area being in communication with the core computer system through a materials handling system.

70. The process according to claim 57, wherein the facility further comprises a pre-defined area for customer service, the pre-defined area being in communication with the core computer system through a materials handling system.

71. The process according to claim 57, wherein the facility further comprises a pre-defined area for customer assistance, the pre-defined area being in communication with the core computer system through a materials handling system.

72. The process according to claim 57 wherein the faculty further comprises a pre-defined food pick up area within the drive-thru pick up area, the prepared food pick up area adapted to deliver food pre-ordered by a customer.

73. The process according to claim 57, wherein the facility further comprises at least one pre-defined area for receiving, storing and transporting goods and services which require predefined environmental controls.

74. The process according to claim 73, wherein environmental controls are selected from the group of humidity controls, product rotation controls, expiration controls, heat controls, refrigeration controls, ambient temperature controls, dry goods handling controls, special handling controls, packaging controls, secure access controls, consolidation and bagging controls and air circulation controls.

75. The process according to claim 56, wherein the core computer system is adapted to monitor or otherwise sense emissions from a vehicle within or adjacent to the facility, and control one or more exhaust control systems in the facility to vent away the emissions from the facility.

76. The process according to claim 56, wherein the structural facility is adapted to annex to, or otherwise structurally couple to, an existing structure specializing in providing wholesale goods or services.

77. The process according to claim 56, wherein the structural facility is adapted to annex to, or otherwise structurally couple to, an existing strip center.

78. The process according to claim 56, wherein the structural facility is adapted to annex to, or otherwise structurally couple to, an existing box store structure.

79. The process according to claim 56, wherein the structural facility is adapted to annex to, or otherwise structurally couple to, an existing outdoor mall structure.

80. The process according to claim 56, wherein the structural facility is adapted to annex to, or otherwise structurally couple to, an existing indoor mall structure.
